(19) United States
(12) Patent Application Publication
(10) Pub. No.: US 2026/0330390 A1
(43) Pub. Date: Oct. 22, 2026

(54) SYSTEM

(71) Applicant: SoftBank Group Corp., Tokyo (JP)

(72) Inventor: Daisuke OGAWA, Tokyo (JP)

(73) Assignee: SoftBank Group Corp., Tokyo (JP)

(21) Appl. No.: 19/650,360

(22) Filed: Apr. 17, 2026

(30) Foreign Application Priority Data
Apr. 21, 2025 (JP) 2025-070024

(51) Int. Cl. G06Q 10/0639

(52) U.S. Cl. CPC G06Q 10/06393

(57) ABSTRACT

The present invention relates to a system in which, in order to fairly and transparently realize personnel evaluation of a manager, a data collection unit automatically collects diverse personnel-related data such as a resignation rate, a transfer request rate, a rank-up record, a performance evaluation, and anonymous feedback, a generative AI analysis unit multilaterally analyzes the resignation rate, the transfer request rate, a rank-up rate, bias detection, a reliability score, an improvement point, and the like using these data, and an evaluation report generation unit automatically generates and distributes an evaluation report for each manager. Thereby, it is possible to break away from conventional subjective and person-dependent evaluation, realize evaluation based on objective and quantitative indicators, utilization of feedback, and a highly transparent evaluation process, and improve reliability and performance of the entire organization.

### CROSS-REFERENCE TO RELATED APPLICATION

The present application claims priority to and incorporates by reference the entire contents of Japanese Patent Application No. 2025-070024 filed in Japan on Apr. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that, in a personnel evaluation system for managers in an organization, conventionally, subjectivity and likes and dislikes of a boss, person-dependent judgment, opacity of evaluation criteria, lack of utilization of feedback from subordinates, mixing of bias, neglect of a record of supporting career growth of subordinates, an increase in resignation and transfer requests, and the like exist in a complex manner, and these have caused serious problems such as a decrease in employee motivation, an outflow of talent, unfair evaluation, hollowing out of organizational culture, and hindrance to building a sound relationship of trust. Specifically, there has been a problem that situations of resignation, job change, and transfer request occurring under a manager and a rank-up record of subordinates are not fairly evaluated, and even if subordinates provide frank anonymous feedback, the content thereof is not appropriately analyzed and utilized, and management ability and reliability of the manager cannot be objectively grasped. Furthermore, since an evaluation process becomes a black box and evaluation criteria and evaluation results are not sufficiently disclosed to related parties, transparency and acceptability of evaluation have been significantly impaired. In order to solve these problems, it is necessary to automatically and comprehensively collect diverse personnel data and anonymous feedback regarding subordinates of a manager, quantitatively and objectively visualize a resignation rate, a transfer request rate, a rank-up rate, presence or absence of a bias, a reliability score, an improvement point, and the like through advanced analysis by generative AI, and provide them to related parties as an evaluation report periodically or in real time, thereby realizing an evaluation system having both fairness and transparency and improving reliability and performance of the entire organization.

### SUMMARY OF THE INVENTION

A means for solving the problem according to the present invention is to configure a system comprising a data collection unit, a generative AI analysis unit, and an evaluation report generation unit in order to fairly and transparently realize personnel evaluation of a manager. First, the data collection unit automatically and comprehensively collects diverse personnel-related data, such as resignation, job change, transfer request, rank-up record, performance evaluation, potential score, and anonymous feedback regarding subordinate employees for each manager, from a plurality of databases and feedback systems inside and outside an organization. Next, the generative AI analysis unit quantitatively calculates a resignation rate, a transfer request rate, and a rank-up rate of the subordinate employees for each manager using various data acquired by the data collection unit, predicts a future rank-up possibility based on performance and potential of the subordinate employees, detects presence or absence of a subjective bias by analyzing a distribution of evaluation scores by the manager and an evaluation tendency for each attribute, and extracts a management style, a reliability score, and an improvement point of the manager by natural language analysis of the anonymous feedback. Finally, the evaluation report generation unit automatically generates an evaluation report for each manager including the resignation rate, the transfer request rate, the rank-up rate, a bias detection result, the reliability score, an improvement point list, and the like obtained by the generative AI analysis unit, and distributes the evaluation report to the manager himself/herself, an upper-level manager, and a human resources department periodically or in real time, thereby ensuring transparency and fairness of an evaluation process and improving reliability and performance of the entire organization.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

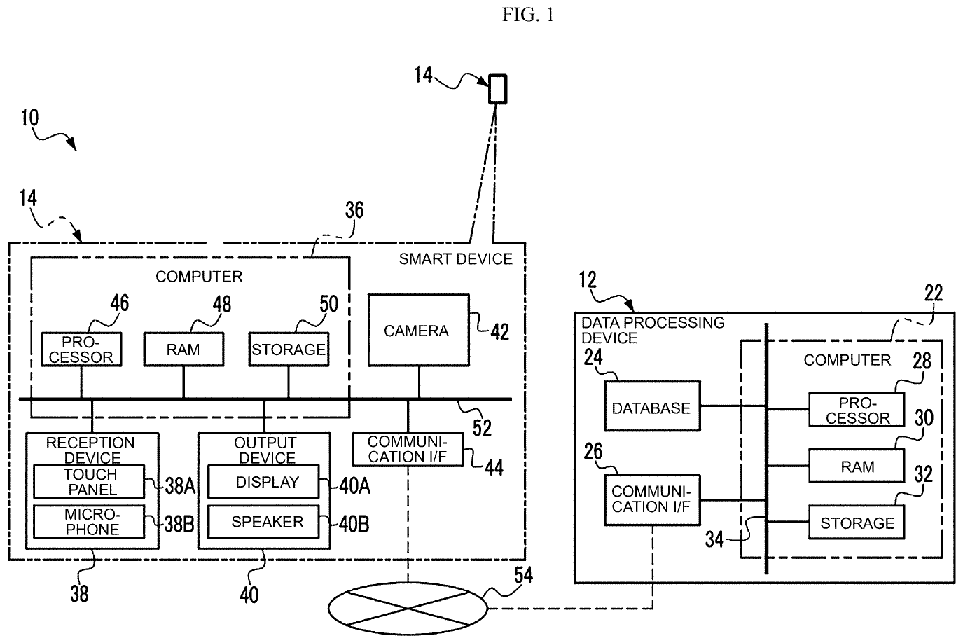

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

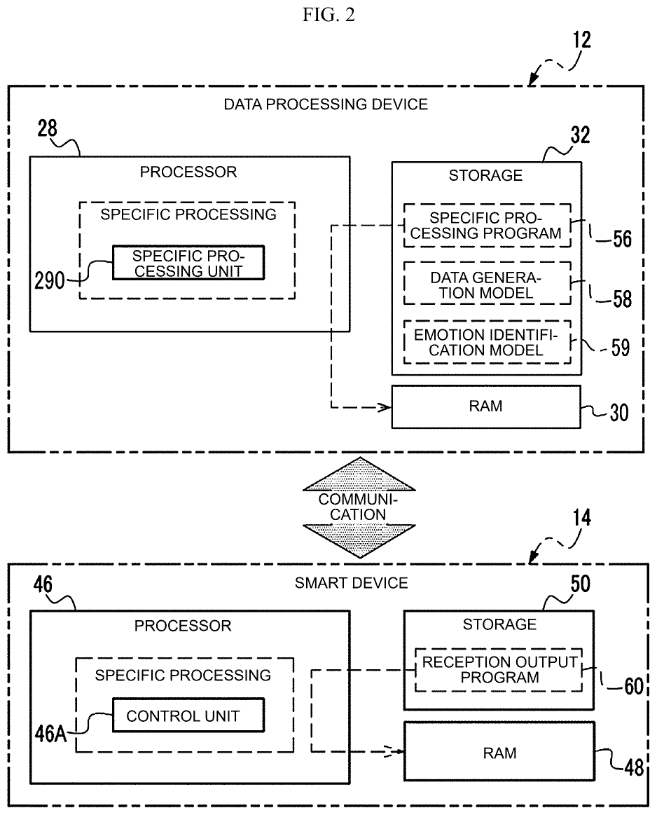

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described more specifically and in detail. The personnel evaluation system of the present invention adopts a client-server architecture with a server and a terminal, and is configured such that a data collection unit, a generative AI analysis unit, an evaluation report generation unit, a database management unit, and an alert notification unit are implemented on the server side, and a user interface unit, a feedback input unit, a report viewing unit, and a review session support unit are implemented on the terminal side. Specifically, the present system operates in a distributed computing environment. The present server is composed of a plurality of computing nodes. The present server includes a parallel computing processor for executing a large language model and a deep learning model at high speed. The present terminal is an information processing terminal that executes a web browser or a dedicated application. The present system uses an encryption protocol in communication between the client and the server. The present data collection unit acquires data from a plurality of external systems using asynchronous communication. The present generative AI analysis unit converts the acquired data into a multidimensional tensor. The present generative AI analysis unit executes an inference process using the converted tensor as an input. The present evaluation report generation unit formats an inference result as structured data. The present database management unit persists data using a distributed relational database or a non-relational database. The present alert notification unit adopts a real-time event-driven architecture. The present user interface unit renders a dynamic web component. The present feedback input unit receives a text input from a user. The present report viewing unit draws the structured data as a visual graph. The present review session support unit establishes a real-time two-way communication session. With this configuration, the present system processes a huge amount of personnel data with low latency. The present system dramatically improves calculation efficiency of an evaluation process. The present system ensures objectivity of personnel evaluation in a large-scale organization. As a specific application field, the present system is applied to global talent management in a multinational corporation on a scale of tens of thousands of people. The present system provides consistent evaluation criteria even in different time zones and language environments. The present system reduces a communication load at a peak time by dynamic allocation of hardware resources. The present system achieves both scalability and high availability. The present system completely digitizes a conventional subjective evaluation process by a human. The present system supports data-driven decision making. The present system directly contributes to productivity improvement of the entire organization.

First, the data collection unit operates on the server, and automatically and periodically collects data from a plurality of internal and external systems and databases, such as a personnel management system, a business management system, a project management system, an employee questionnaire system, an anonymous feedback system, an attendance management system, an internal SNS, an email system, and a training management system in the organization, by means of API linkage, batch processing, file import, or the like. For example, multifaceted and comprehensive information regarding the subordinate employees of the manager is collected, such as an employee's resignation date, transfer request application date, presence or absence of job change activity, past rank-up record, performance evaluation score, potential score, anonymously posted feedback comment, result of 360-degree evaluation, attendance data (lateness, early departure, overtime, paid leave acquisition status), project participation history, submission status of business deliverables, number of remarks and content on the internal SNS, number of sent and received emails, training attendance history, qualification acquisition status, record of self-development activity, health checkup result, and stress check result. For example, it is possible to acquire detailed data such that a certain employee has submitted a transfer request twice in the past year, attended training three times, experienced being a project leader once, and made an average of 30 remarks per month on the internal SNS. Specifically, the present data collection unit executes a dedicated connector module for a plurality of heterogeneous data sources. The present data collection unit communicates with an external system using a stateless communication protocol. The present data collection unit normalizes the acquired raw data into an intermediate data format. The present data collection unit analyzes unstructured data and semi-structured data including a natural language text, numerical data, and a time stamp. The present data collection unit executes preprocessing such as complementation of a missing value and removal of an outlier. The present data collection unit converts the preprocessed data into a multidimensional feature vector. The present data collection unit encodes, for example, an action history of the employee as a time-series numerical array. The present data collection unit maps text data to a high-dimensional vector space by a word embedding method. The present data collection unit integrates these vector data to generate a single input tensor. The present data collection unit transfers the generated input tensor to the subsequent generative AI analysis unit. By this processing, the present system makes it possible to process a huge amount of data in different formats with a unified calculation model. The present system significantly reduces a calculation cost required for data integration. The present system exceeds the limit of manual data collection by a human, and realizes real-time and comprehensive data processing. As a specific application field, the present system is applied to human resource allocation optimization in a large company having a complex matrix organization. The present system quantitatively captures a minute behavioral change of the employee. The present system contributes to early discovery of a turnover risk and discovery of a hidden talent. The present data collection unit processes data asynchronously using a distributed message queue. The present data collection unit improves fault tolerance of the system. The present data collection unit maintains a processing speed by horizontal expansion even when a data amount increases. The present data collection unit combines periodic batch processing and real-time stream processing. The present data collection unit always keeps freshness and accuracy of data at the highest level.

The database management unit organizes these various data in chronological order, and manages the data so that the data can be searched, extracted, and aggregated from various perspectives such as for each manager, for each employee, for each department, and for each project. For example, a data infrastructure for detailed analysis is constructed, such as a transition of a resignation rate of subordinate employees of a specific manager in the past three years, a year-by-year comparison of a transfer request rate of a certain department, and a distribution of performance evaluations of members in a specific project. Specifically, the present database management unit executes a high-availability data store constructed on a distributed file system. The present database management unit constructs an index structure specialized for time-series data. The present database management unit holds a tree structure index or a hash index on a memory for processing a multidimensional search query at high speed. The present database management unit normalizes data using a manager identifier or an employee identifier as a primary key. The present database management unit defines a relation using a department code or a project identifier as a foreign key. The present database management unit records a transaction log every time addition or update of data occurs. The present database management unit guarantees consistency and durability of data. The present database management unit saves past history data to a cold storage using a compression algorithm. The present database management unit arranges frequently accessed latest data in an in-memory cache. By this processing, the present system realizes a response speed in milliseconds even for petabyte-class large-scale data. The present system equally allocates a calculation load of complex aggregation processing among distributed nodes. The present system eliminates a bottleneck of the database and improves processing capability of the entire system. As a specific application field, the present system is applied to formulation of a long-term human resource development plan in a historic large company possessing decades of personnel data. The present system makes it possible to instantly search a huge amount of past success cases and failure cases. The present system provides a construction infrastructure for a precise prediction model based on data. The present database management unit executes encrypted storage of data as a standard. The present database management unit minimizes a leakage risk of personal information. The present database management unit strictly manages a viewing authority for each user using an access control list. The present database management unit automatically generates an audit log and satisfies a compliance requirement.

The generative AI analysis unit operates on the server, and performs various AI analyses using the data accumulated in the database management unit. As the generative AI, for example, a large language model, a gradient boosting model, a random forest, a neural network, a natural language processing model, a clustering model, an anomaly detection model, and the like are used in combination. First, in order to calculate a resignation rate and a transfer request rate of the subordinate employees for each manager, for example, the number of employees who resigned or the number of employees who submitted a transfer request in the past year is aggregated and divided by the total number of subordinate employees to obtain a quantitative index. For example, when there are 20 employees under a certain manager, and 3 of them resign and 2 of them submit a transfer request, the resignation rate is 15 percent and the transfer request rate is 10 percent. Specifically, the present generative AI analysis unit adopts an ensemble learning architecture integrating a plurality of machine learning models. The present generative AI analysis unit receives a multidimensional tensor including an action history and text data of the employee as input data. The present input tensor is, for example, a 640-dimensional vector obtained by combining a 512-dimensional text embedding vector and a 128-dimensional numerical feature vector. As a specific example of the present input tensor, a time-series array of past evaluation scores and an array of emotion scores extracted from an internal communication tool are included. The present generative AI analysis unit inputs these input tensors to a neural network equipped with a multilayer perceptron or a self-attention mechanism. The present neural network learns a long-term dependency in time-series data. The present neural network is pre-trained using a cross-entropy error function. The present neural network optimizes a weight parameter by a gradient descent method. The present generative AI analysis unit outputs a continuous value score in a range of 0 to 1 indicating a turnover probability or a transfer request probability of each employee as an inference result. As a specific example of the present output score, numerical values such as a turnover probability of 0.85 and a transfer request probability of 0.62 are calculated. The present generative AI analysis unit further aggregates these scores for each manager to calculate a risk index in units of organizations. The present generative AI analysis unit transmits this risk index to the subsequent evaluation report generation unit and alert notification unit. In this subsequent processing, the present system automatically fires a warning when the risk index exceeds a predetermined threshold. By this processing, the present system specifies a complex correlation overlooked by a simple statistical calculation in a high-dimensional space. The present system dramatically improves prediction accuracy. The present system realizes objective risk evaluation that does not depend on human intuition. As a specific application field, the present system is applied to drafting of a human resource outflow prevention measure in a rapidly growing startup company or a company undergoing large-scale organizational restructuring. The present system enables a data-driven proactive personnel measure. The present generative AI analysis unit generates an attention map visualizing an inference process of the model. The present generative AI analysis unit presents a basis for prediction in a form understandable to a human.

Regarding the rank-up record of subordinates, for example, the number of employees promoted and a promotion rate in the past two years are calculated, and further, a performance evaluation score, project leader experience, self-development activity history, and the like of the promoted employees are analyzed to evaluate a career support record of the manager from multiple angles. For example, when 5 of the subordinate employees are promoted, 3 of them are experienced new project leaders, and 2 of them have acquired qualifications, the AI determines that “career support is actively performed”. Specifically, the present generative AI analysis unit executes a dedicated classification algorithm for evaluating the career support record. The present generative AI analysis unit acquires structured data including a promotion history, a transition of the performance evaluation score, a project participation history, and a qualification acquisition history of the subordinate employees as input data. The present generative AI analysis unit normalizes this structured data to generate a feature vector of each employee. As a specific example of the present feature vector, an integer value indicating the number of promotions in the past two years, a floating-point number indicating an average value of evaluation scores, and binary data indicating presence or absence of leader experience are included. The present generative AI analysis unit inputs this feature vector to a support vector machine or a gradient boosting decision tree. The present model is supervised-learned using data of past excellent managers as a correct label. The present model classifies the input feature vector on a multidimensional feature space. The present model calculates a score from 0 to 100 indicating a career support ability of the manager as an output. As a specific example of the present output score, numerical values such as a career support score of 85 points and a development ability score of 92 points are generated. The present generative AI analysis unit transfers this output score to the subsequent evaluation report generation unit. In this subsequent processing, the present system automatically adjusts a comprehensive evaluation of the manager based on this score. By this processing, the present system quantitatively evaluates not only a superficial promotion rate but also a development process behind it. The present system visualizes a true management ability of the manager. The present system significantly improves fairness and acceptability of evaluation. As a specific application field, the present system is applied to selection of a next-generation leader and an aptitude test for a management position. The present system accurately specifies human resources driving long-term growth of the organization. The present generative AI analysis unit calculates importance of a feature amount, and specifies which development action contributed most to promotion. The present generative AI analysis unit provides this importance information to the manager as feedback. The present generative AI analysis unit promotes sharing of development know-how of the entire organization.

The generative AI predicts a possibility of ranking up within the next half year using the performance evaluation score, the potential score, business results, project leader experience, self-development activity history, training attendance history, remark content on the internal SNS, health checkup and stress check results, and the like of the subordinate employees as inputs. For example, for an employee whose performance evaluation is high, self-development activity is active, and stress check result is also good, the AI determines that “promotion possibility is high”, and reflects it in the evaluation of the career support record of the manager. Specifically, the present generative AI analysis unit executes a time-series prediction model for predicting future growth of the employee. The present generative AI analysis unit acquires the performance evaluation score, the potential score, business results, project leader experience, self-development activity history, training attendance history, remark content on an internal communication tool, health checkup result, and stress check result of the employee as input data. The present generative AI analysis unit constructs a multivariate time-series tensor in which these data are arranged along a time axis. As a specific example of the present input tensor, an array of monthly evaluation scores for the past 36 months and a numerical array indicating a transition of monthly learning time are included. The present generative AI analysis unit inputs this time-series tensor to a long short-term memory network or a one-dimensional convolutional neural network. The present network is trained to predict a future fluctuation from a past data pattern. The present network updates a weight through backpropagation so as to minimize a mean square error. The present generative AI analysis unit generates a probability distribution indicating a rank-up probability within the next half year as an output. As a specific example of the present output data, predicted values such as a promotion probability of 78 percent within half a year and a promotion probability of 95 percent within one year are calculated. The present generative AI analysis unit saves this prediction result in the subsequent database management unit, and transmits it to the evaluation report generation unit. In this subsequent processing, the present system automatically recommends an optimal training program using this prediction result. By this processing, the present system scientifically evaluates not only a past record but also future potential. The present system maximizes return on investment in human resource development. The present system directly contributes to motivation improvement of the employee. As a specific application field, the present system is applied to career path design for highly specialized technical and research positions. The present system dynamically generates an optimal career plan according to individual aptitude. The present generative AI analysis unit calculates uncertainty of prediction as a confidence interval. The present generative AI analysis unit supports drafting of a flexible personnel plan considering a risk.

Regarding bias detection of subordinate evaluation by the manager, the AI detects presence or absence of a bias and calculates a bias score using a statistical method or a clustering method, for example, when a distribution of evaluation scores is extremely biased, or when there is a biased evaluation tendency for a specific attribute (gender, age, job type, department of origin, etc.). For example, when a certain manager consistently gives a low evaluation to female employees, or gives a high evaluation to those from a specific department, the AI determines that “there is a bias risk”, and describes a specific evaluation tendency in a report. Specifically, the present generative AI analysis unit executes an anomaly detection algorithm for ensuring fairness of evaluation. The present generative AI analysis unit acquires a list of evaluation scores given by the manager and attribute data (gender, age, job type, department of origin, etc.) of an evaluation target person as input data. As a specific example of the present input data, an array of 500 evaluation scores given by a specific manager in the past three years and an attribute vector of an employee corresponding to each score are included. The present generative AI analysis unit executes clustering processing in a multidimensional space using this input data. The present generative AI analysis unit forms a group of evaluation patterns using a K-means method or a density-based spatial clustering algorithm. The present generative AI analysis unit calculates a statistical correlation between the formed cluster and the attribute data. When the evaluation score is significantly biased with respect to a specific attribute, the present generative AI analysis unit calculates its deviation. The present generative AI analysis unit generates a bias score indicating a degree of bias and an attribute label causing the bias as an output. As a specific example of the present output data, numerical values such as a bias score of 0.8 (high risk) for gender and a bias score of 0.2 (low risk) for a department of origin are output. The present generative AI analysis unit transmits this output result to the subsequent alert notification unit. In this subsequent processing, the present system issues an immediate warning to the human resources department when the bias score exceeds a threshold. By this processing, the present system mathematically detects an unconscious prejudice of a human, and forcibly maintains objectivity of evaluation. The present system promotes diversity and inclusion of the organization. The present system prevents turnover of an employee due to unfair evaluation. As a specific application field, the present system is applied to an audit of an evaluation process in a global company promoting diversity. The present system prevents a risk of legal compliance violation in advance. The present generative AI analysis unit executes a decision tree model for specifying a cause of the bias in parallel. The present generative AI analysis unit automatically generates a specific action plan for bias correction.

In analysis of the anonymous feedback, the generative AI performs keyword and emotion analysis such as “reliable”, “easy to consult”, “unfair”, “lack of support”, “insufficient explanation”, “evaluation is too strict”, and “little communication” using a natural language processing technology, and extracts a reliability score and an improvement point list for each manager. For example, when there are many negative opinions, the content is summarized, and a specific improvement proposal such as “lack of communication”, “bias in business load”, “unclear evaluation criteria”, and “deficiency in support system” is automatically generated. Furthermore, for example, a time-series change of feedback is analyzed, and when the reliability score is in a downward trend, the AI determines that “early improvement intervention is necessary”, and notifies the manager and the human resources department through the alert notification unit. Specifically, the present generative AI analysis unit executes an advanced natural language processing pipeline for analyzing unstructured text data. The present generative AI analysis unit acquires an anonymous feedback text posted by the employee as input data. As a specific example of the present input data, a natural language character string such as “boss's instruction is unclear and hinders business” or “always kindly consults with me” is included. The present generative AI analysis unit divides this text data into a token string using a morphological analyzer or a subword tokenizer. The present generative AI analysis unit inputs this token string to a pre-trained transformer-based language model. The present language model understands a context using a self-attention mechanism, and calculates a semantic representation vector of each token. The present generative AI analysis unit classifies emotion polarity (positive, negative, neutral) using this semantic representation vector. The present generative AI analysis unit further extracts a specific topic or keyword from the text using a named entity extraction algorithm. The present generative AI analysis unit generates a reliability score for each manager and an improvement point list based on the extracted topic as an output. As a specific example of the present output data, a reliability score of 0.45 and structured data such as “increase in communication frequency” and “clarification of instruction” as an improvement point list are output. The present generative AI analysis unit transfers this output data to the subsequent evaluation report generation unit. In this subsequent processing, the present system monitors a time-series change of the reliability score, and activates the alert notification unit when a rapid decrease is detected. By this processing, the present system converts a large amount of qualitative opinions into a quantitative index. The present system saves a human the trouble of reading all comments, and instantly highlights an important issue. The present system improves openness of the organization and enhances psychological safety. As a specific application field, the present system is applied to monitoring of management quality in an organization centered on remote work. The present system accurately measures soundness of a team even in an environment where face-to-face communication is insufficient. The present generative AI analysis unit discovers a potential organizational issue using topic modeling. The present generative AI analysis unit automatically generates a strategic proposal to a management layer.

The evaluation report generation unit operates on the server, and automatically generates an evaluation report for each manager including the resignation rate, the transfer request rate, the rank-up rate, the bias detection result, the reliability score, the improvement point list, and the like obtained by the generative AI analysis unit. For example, specific numerical values and comments are described in the report, such as “resignation rate in the past year is 15 percent”, “transfer request rate is 5 percent”, “promotion rate of subordinates is 20 percent”, “bias score is low risk”, “reliability score is 0.8”, “improvement point: improvement in communication frequency is necessary”, and “anonymous feedback: ‘support is generous’, ‘evaluation is strict’, ‘explanation is insufficient’”. The report is automatically updated periodically (for example, monthly or quarterly) or in real time, and is distributed from the server in a form viewable by the manager himself/herself, an upper-level manager, and a human resources department. Specifically, the present evaluation report generation unit executes data format processing for integrating various quantitative indexes and qualitative data output from the generative AI analysis unit. The present evaluation report generation unit receives structured data in JSON format including the resignation rate, the transfer request rate, the rank-up rate, the bias score, the reliability score, and the improvement point list as input data. The present evaluation report generation unit maps this structured data to a predetermined report template. The present evaluation report generation unit executes a rendering engine for converting numerical data into a visually easy-to-understand graph or chart. The present evaluation report generation unit draws, for example, a transition of the resignation rate as a line graph, and draws the bias score as a radar chart. The present evaluation report generation unit automatically generates an explanatory text from numerical data using a natural language generation algorithm. The present evaluation report generation unit generates an electronic document in HTML format or PDF format as an output. As a specific example of the present output data, a dashboard screen in which each index is color-coded or a detailed report file for printing is generated. The present evaluation report generation unit distributes this output document to the subsequent report viewing unit. In this subsequent processing, the present system dynamically filters display content according to an access authority of a user. By this processing, the present system provides a complex analysis result in an intuitively understandable format. The present system significantly reduces a cognitive load required for data interpretation by the manager or a human resources person in charge. The present system supports rapid decision making based on data. As a specific application field, the present system is applied to creation of an official report material in a quarterly personnel evaluation meeting or management meeting. The present system completely automates report creation business, and dramatically improves business efficiency of the human resources department. The present evaluation report generation unit incorporates a multilingual translation module. The present evaluation report generation unit provides a report translated into a local language to each base of a global company in real time. The present evaluation report generation unit tracks a viewing history of the report, and analyzes which index is attracting the most attention.

The alert notification unit transmits an alert in real time to the manager, the human resources department, and the management layer when a serious risk for the organization is detected, for example, when the resignation rate or the transfer request rate rapidly increases, when the reliability score rapidly decreases, or when the bias score is determined to be high risk. For example, a specific situation and a recommended action are notified, such as “resignation rate of subordinate employees has exceeded 20 percent in the past three months. Urgent response is necessary” or “many opinions that ‘evaluation is unfair’ have been received in anonymous feedback. Review of evaluation criteria is recommended”. Specifically, the present alert notification unit executes an event-driven background process that constantly monitors a state change in the system. The present alert notification unit receives various risk scores and index data streamed in real time from the generative AI analysis unit as input data. As a specific example of the present input data, an array of resignation prediction scores updated every second and a numerical value of a bias score calculated daily are included. The present alert notification unit queries this input data to a rule engine on a memory. The present rule engine holds a plurality of predefined threshold conditions. The present alert notification unit determines whether the input data matches the threshold condition by a logical operation. When the condition is matched, the present alert notification unit generates an alert message instructing a specific action as an output. As a specific example of the present output data, a text message “resignation risk is rapidly increasing in team of manager D” and flag data indicating importance are generated. The present alert notification unit passes this output message to a subsequent communication module, and transmits it to a target user as an email, a chat tool, or a push notification of a dedicated application. In this subsequent processing, the present system tracks an opening status and a response status of the alert, and performs an escalation notification to an upper-level manager when unresponded. By this processing, the present system detects a potential crisis in the organization before it becomes apparent, and enables rapid intervention. The present system prevents organizational collapse due to leaving a problem unattended. The present system reduces a management cost by automating risk management. As a specific application field, the present system is applied to early discovery of harassment and relief of a person with poor mental health. The present system functions as an important infrastructure for protecting safety and health of the employee. The present alert notification unit learns a past alert response history using machine learning. The present alert notification unit includes an adaptive threshold adjustment function that reduces false detection and filters only a truly important alert. The present alert notification unit optimizes timing and frequency of notification according to an action pattern of the user.

The user interface unit on the terminal side allows each user, such as a manager, an employee, and a human resources staff member, to access the server through a browser or a dedicated application, and perform viewing of an evaluation report, posting of feedback, execution of a review session, confirmation of an improvement proposal, and the like. For example, the manager can check his/her own evaluation report, grasp a reliability score and an improvement point, and review management behavior. The employee can post feedback anonymously, and check a past feedback history and his/her own career growth status. The human resources staff member can grasp an evaluation tendency and a bias risk of the entire organization, and utilize them as evidence for system improvement. Specifically, the user interface unit is implemented as a front-end application operating on the client terminal. The user interface unit renders a dynamic web component constructed using HTML, CSS, and JavaScript. The user interface unit establishes secure WebSocket communication or HTTPS communication with the server. The user interface unit executes single sign-on processing using user authentication information. The user interface unit acquires an event such as a mouse click, a keyboard input, and a touch operation from the user as input data. Specific examples of the input data include a change event of a drop-down for selecting a specific report period, and an input stroke of a feedback text. The user interface unit converts this input event into an asynchronous request, and transmits it to each processing unit on the server side. The user interface unit receives response data from the server, and redraws only a specific part of the screen at high speed using a virtual DOM. As specific examples of the output data, a graph reflecting the latest evaluation score and a new alert badge are displayed on the screen. In the subsequent processing, the system records an operation history of the user as a log, and utilizes it for improvement of the interface. By this processing, the system provides a smooth operation experience without delay to the user. The system realizes intuitive operability despite being a complex data analysis system. The system improves a system utilization rate of the user. As a specific application field, the system is applied to a company-wide common portal site used by diverse employees with different IT literacy. The system adopts a responsive design, and supports access from diverse devices such as a smartphone and a tablet. The user interface unit complies with accessibility standards, and provides screen reader support and a high contrast mode for visually impaired persons. The user interface unit includes a cache function capable of viewing a part of data even in an offline state.

The feedback input unit provides an interface allowing the employee to post feedback to the manager anonymously. For example, a plurality of questions and a free-text column, such as “about the support system of the boss”, “about the fairness of evaluation”, and “about the frequency of communication”, are provided so that the employee can post a frank opinion. The posted feedback is immediately transmitted to the server, and analyzed by the generative AI analysis unit. Specifically, the feedback input unit executes a dedicated module for safely and reliably collecting qualitative text data from the user. The feedback input unit receives a text character string typed into an input form by the employee and selective answer data as input data. Specific examples of the input data include a selection value of a five-level evaluation radio button and a free-text description of up to 2000 characters. The feedback input unit executes input validation on this input data on the client side to prevent mixing of an unauthorized character or script. The feedback input unit encrypts the input data using a public key cryptography method. The feedback input unit transmits the encrypted data to the server using an asynchronous communication protocol. The feedback input unit completely separates or hashes identification information of the user at the time of transmission, and mathematically guarantees anonymity. The feedback input unit generates a status code indicating completion of transmission as an output, and returns it to the user interface unit. As specific examples of the output data, an HTTP status 200 and a JSON object of a success message are generated. In the subsequent processing, the system decrypts the received encrypted data in a secure area, passes it to the generative AI analysis unit, and executes natural language processing. By this processing, the system provides a safe environment where the employee can state a frank opinion without fear of retaliation. The system secures high-quality raw data for extracting a true problem of the organization. The system simultaneously satisfies integrity and confidentiality of data. As a specific application field, the system is applied to an internal whistleblowing contact for compliance violations and a direct suggestion box system for the management layer. The system enhances a self-purification action of the organization. The feedback input unit includes an automatic backup function for temporarily saving data in the middle of input in a local storage. The feedback input unit prevents data loss even when a network is disconnected. The feedback input unit supports a function of accepting input in multiple languages and automatically translating it on the server side.

The report viewing unit provides an interface allowing the manager and the human resources staff member to view the evaluation report distributed from the server. For example, information is displayed in a visually easy-to-understand format, such as a resignation rate transition graph for the past one year, a chronological change in a transfer request rate, a list of a rank-up record, a heat map of a bias detection result, a transition graph of a reliability score, and details of an improvement point list. Specifically, the report viewing unit executes a data visualization engine that converts complex structured data distributed from the server into a visually interpretable format. The report viewing unit receives report data in a JSON format transmitted from the evaluation report generation unit as input data. Specific examples of the input data include a numerical array of the resignation rate for the past 12 months and multidimensional matrix data indicating the bias detection result. The report viewing unit analyzes this input data, and calls an optimal graph drawing library. The report viewing unit generates, for example, a line graph having an interactive zoom function for time-series data, and generates a heat map or a scatter plot for multidimensional data. The report viewing unit generates an SVG or Canvas element rendered on the browser as an output. As a specific example of the output data, a dynamic graph component that pops up detailed numerical values upon mouse-over is generated. In the subsequent processing, when the user clicks a specific data point on the graph, the system requests detailed data (drill-down data) behind it from the server. By this processing, the system visually highlights a hidden pattern or an abnormal value in a huge amount of data. The system utilizes the processing capability of the human visual cortex, and dramatically improves the speed of data understanding. The system enables even a user without high data literacy to utilize an advanced analysis result. As a specific application field, the system is applied to an executive dashboard for the management layer to grasp the soundness of the entire organization at a glance. The system always displays information updated in real time in the latest state. The report viewing unit provides a function of customizing a layout of the dashboard according to the user's preference. The report viewing unit includes a function of exporting a specific graph as an image file or a PDF. The report viewing unit adopts a lazy loading technology for minimizing data loading time.

The review session support unit supports the manager and the subordinate employee to formulate a specific action plan while referring to the evaluation report, a feedback history, an improvement proposal by AI, and the like when periodically conducting a review session. For example, an agenda and an action list automatically generated by the AI, such as “factor analysis of an increase in the resignation rate in this term”, “background of a decrease in the reliability score”, and “specific measure for strengthening career support”, are presented to improve the quality of the review session. Specifically, the review session support unit executes a real-time synchronization module for structuring communication between the manager and the employee and promoting an effective dialogue. The review session support unit acquires past evaluation data of the target manager and employee, the feedback history, and an improvement proposal list generated by the generative AI analysis unit as input data. Specific examples of the input data include numerical data indicating an achievement degree of a goal set in the previous session, and a problem keyword “lack of communication” extracted by the AI. The review session support unit generates a dynamic agenda guiding the progress of the session based on this input data. The review session support unit generates an interactive workspace screen shared on the screen as an output. As specific examples of the output data, an input form of the action plan that can be simultaneously edited by both parties and a progress bar indicating the progress of discussion are displayed. In the subsequent processing, the system saves the action plan agreed upon during the session in the database management unit, and reuses it as input data at the time of the next session. By this processing, the system standardizes an interview process that tends to be personalized, and forcibly constructs a high-quality feedback loop. The system prevents the interview from becoming a mere formality, and prompts a substantial behavioral change. The system resolves a perception gap between the boss and the subordinate using objective data. As a specific application field, the system is applied as a platform for a regular 1-on-1 meeting in a company that has introduced a management by objectives system or OKR. The system provides an environment for discussing while looking at the same data through screen sharing in an online interview under a remote work environment. The review session support unit includes a function of cooperating with a voice recognition AI, converting the voice of the interview into text in real time, and automatically generating minutes. The review session support unit analyzes an utterance ratio and a change in emotion during the interview, and presents a hint for better communication in real time.

Furthermore, for example, when the manager implements an improvement action, the content thereof is reported from the terminal to the server, and the AI monitors a subsequent change in the resignation rate and the reliability score, whereby an improvement effect can be quantitatively evaluated. For example, effect verification of an improvement measure can also be automated, such as “as a result of increasing the communication frequency to once a week, the reliability score increased from 0.6 to 0.8”. Specifically, the system executes a feedback loop mechanism for tracking an implementation status of the improvement action and a change in an organizational index resulting therefrom. The system acquires an implementation record of the improvement action input from the terminal by the manager, and behavior data and feedback data of the subordinate employee in a certain period thereafter as input data. Specific examples of the input data include a text log “conducted a 1-on-1 meeting once a week” and a time-series array of the reliability score collected in one month thereafter. The system inputs this input data to a causal inference algorithm or a reinforcement learning model. The model statistically estimates a causal relationship between the implemented action and the change in the index. The system generates an effect size score indicating the effectiveness of the improvement measure and an estimated value of return on investment as an output. As specific examples of the output data, numerical values such as an improvement width of the reliability score by the measure of plus 0.2 points and a reduction rate of a resignation risk of 15 percent are calculated. The system feeds back this output result to the subsequent generative AI analysis unit, and utilizes it as learning data for improving the accuracy of a future improvement proposal. By this processing, the system goes beyond mere data visualization, and scientifically verifies which action actually brings an effect. The system automatically extracts a best practice of the entire organization, and accumulates it as a knowledge base. The system makes it possible to rotate a PDCA cycle of a personnel measure at high speed. As a specific application field, the system is applied to a company-wide organizational culture reform project and effect measurement of leadership training for managers. The system quantitatively proves whether taking the training leads to an actual change in management behavior. The system supports a data-driven management decision to terminate a less effective measure early and concentrate resources on an effective measure. The system includes a function of evaluating a plurality of improvement measures in parallel using an A/B testing framework.

As described above, the embodiment of the present invention realizes a system that realizes personnel evaluation of the manager fairly and transparently, and contributes to improvement of reliability and performance of the entire organization by adopting a configuration in which data collection, multifaceted analysis by the generative AI, evaluation report generation, alert notification, and database management are centrally executed on the server side, and the user performs report viewing, feedback posting, a review session, implementation/reporting of an improvement action, and the like on the terminal side. The generative AI plays a core role in the system, such as integrated analysis of data, bias detection, feedback analysis by natural language processing, prediction of a future rank-up possibility, automatic generation of an improvement proposal, and effect verification of an improvement measure, breaks away from conventional personalized and subjective evaluation, and enables realization of a personnel evaluation system having both objectivity and transparency. Specifically, the system executes an integrated control module that links each processing unit on a distributed architecture and completely automates a series of pipelines from data collection to analysis, visualization, and action verification. The system continuously receives a streaming of a wide variety of raw data generated from all digital contact points in the organization as input data. As specific examples of the input data, daily attendance stamping data, email transmission/reception logs, chat message histories, and periodic questionnaire answer data are continuously input. The system inputs these data to a large language model or a deep learning model, which is the core of the generative AI analysis unit, and executes feature extraction and inference in a high-dimensional space in real time. The system generates comprehensive dashboard data indicating the soundness of the organization, an individual risk alert, and an optimized action plan as an output. As specific examples of the output data, an update result of a resignation prediction model at a company-wide level and a personalized management guide for each manager are generated. In the subsequent processing, the system push-distributes these output data to the terminal of each user, and prompts a behavioral change of the entire organization. By this processing, the system processes personnel data at a scale and speed exceeding human cognitive limits, and establishes an extremely objective evaluation base excluding subjectivity and prejudice. The system dramatically improves the quality of evaluation while reducing enormous time and cost required for a personnel evaluation process. The system enhances employee engagement, and ultimately directly contributes to improvement of corporate performance. As a specific application field, the system is applied as a base for highly transparent information disclosure to investors in a listed company promoting human capital management. The system provides objective evidence for proving social sustainability of a company in the context of ESG investment. The system is constructed using a cloud-native container technology, and includes an auto-scaling function of dynamically expanding/reducing computational resources according to demand. The system has a continuous integration environment capable of always deploying the latest AI algorithm without downtime.

### (System Configuration)

The system according to the present embodiment includes a data collection unit, a database management unit, a generative AI analysis unit, an evaluation report generation unit, an alert notification unit, a user interface unit, a feedback input unit, a report viewing unit, and a review session support unit. The data collection unit is a unit that automatically and periodically collects data from a plurality of internal and external systems and databases, such as a personnel management system, a business management system, a project management system, an employee questionnaire system, an anonymous feedback system, an attendance management system, an internal SNS, an email system, and a training management system in the organization, by means of API linkage, batch processing, file import, and the like. For example, multifaceted and comprehensive information regarding the subordinate employee of the manager is collected, such as a resignation date and a transfer request application date of the employee, presence or absence of job change activity, a past rank-up record, a performance evaluation score, a potential score, an anonymously posted feedback comment, a result of a 360-degree evaluation, lateness, early departure, overtime, and paid leave acquisition status as attendance data, a project participation history, a submission status of business deliverables, the number of remarks and contents on the internal SNS, the number of sent and received emails, a training attendance history, a qualification acquisition status, a record of self-development activities, a health checkup result, and a stress check result. For example, it is possible to acquire detailed data such that a certain employee has submitted a transfer request twice in the past one year, attended training three times, experienced a project leader once, and made remarks on the internal SNS 30 times a month on average. Specifically, the system is composed of a plurality of independent component groups based on a microservices architecture. The data collection unit executes a data ingest pipeline operating on an edge node responsible for an interface with an external system. The data collection unit acquires a response payload of a REST API, a batch stream of a CSV file, and a transaction log of a database as input data. Specific examples of the input data include a basic information JSON object of the employee acquired from the personnel system, and a daily working hour CSV file exported from the attendance system. The data collection unit executes schema validation, data cleansing, and format conversion on this input data. The data collection unit converts, for example, a date character string into a UNIX timestamp, and complements a missing value with an average value or a median value. The data collection unit generates a normalized data record conforming to a standard format inside the system as an output. As specific examples of the output data, a Parquet format file in which all attributes are typed and a message topic of a distributed messaging system are generated. The data collection unit asynchronously transfers this output data to the subsequent database management unit and generative AI analysis unit. By this processing, the system centrally integrates information from a wide variety of data sources, and constructs a robust data base for subsequent advanced analysis processing. The system eliminates data siloization, and enables cross-organizational data utilization. The system completely eliminates human input errors and data omissions by automating data collection. As a specific application field, the system is applied to an integration project of personnel data in a corporate group in which a plurality of different system environments coexist due to M&A. The system absorbs different data formats, and rapidly applies a unified evaluation standard. The data collection unit adopts a change data capture technology for tracking a change history of data, and realizes real-time data synchronization. The data collection unit applies a data compression algorithm for saving a network bandwidth.

The database management unit is a unit that organizes the wide variety of data acquired by the data collection unit in chronological order, and manages the data so that the data can be searched, extracted, and aggregated from various perspectives such as for each manager, for each employee, for each department, and for each project. For example, a data base for detailed analysis is constructed, such as a resignation rate transition of the subordinate employees of a specific manager in the past three years, a year-by-year comparison of a transfer request rate of a certain department, a distribution of performance evaluation of members in a specific project, a career path history for each employee, visualization of cross-departmental talent mobility, a chronological change in anonymous feedback, and correlation analysis between a training attendance history and a promotion record. For example, it is also possible to extract a period when the transfer request rate is high for each department, and collate it with the timing of organizational restructuring. Specifically, the database management unit executes a distributed column-oriented database engine capable of processing petabyte-class data. The database management unit receives a stream of the normalized data record transferred from the data collection unit as input data. Specific examples of the input data include a behavior log of the employee arriving at a frequency of thousands of cases per second, and a data set of an evaluation score batch-loaded daily. The database management unit partitions this input data in a plurality of dimensions of a time axis, an organizational hierarchy, and a personal ID, and distributes and arranges it in a storage node. The database management unit applies a compression technology such as dictionary encoding and run-length encoding to each column in order to enable a high-speed aggregation query. The database management unit generates a result set for an SQL query from the user interface unit or the generative AI analysis unit as an output. As specific examples of the output data, an aggregation table indicating a transition of the transfer request rate in the past five years in a specific department and statistical data indicating a variance of the evaluation score of a specific project member are returned in milliseconds. In the subsequent processing, the system caches this result set on a memory, and further improves a response speed to the same query. By this processing, the system enables complex multidimensional analysis on a huge amount of history data to be executed in real time. The system eliminates waiting time required for data extraction, and provides an analysis environment that does not hinder thinking. The system replicates data to a plurality of geographical regions in order to enhance availability and fault tolerance of data. As a specific application field, the system is applied as a back end of a company-wide talent management system in a global company having tens of thousands of employees. The system provides a data base necessary for simulation of organizational restructuring and formulation of a future personnel plan. The database management unit automatically applies a data lifecycle management policy, and automatically migrates old data to inexpensive cold storage. The database management unit implements role-based access control, and blocks unauthorized access to confidential data.

The generative AI analysis unit is a unit that performs various AI analyses using the data accumulated in the database management unit, and uses, for example, a large language model, a gradient boosting model, a random forest, a neural network, a natural language processing model, a clustering model, an anomaly detection model, and the like in combination. The generative AI analysis unit calculates a resignation rate and a transfer request rate of the subordinate employees for each manager, and for example, aggregates the number of employees who resigned and the number of employees who submitted a transfer request in the past one year, and divides it by the total number of subordinate employees to obtain a quantitative index. For example, when there are 20 employees under a certain manager, and 3 of them resign and 2 of them submit a transfer request, the resignation rate is 15 percent and the transfer request rate is 10 percent. Furthermore, regarding a rank-up record of subordinates, for example, the number of employees promoted and a promotion rate in the past two years are calculated, and a performance evaluation score, project leader experience, a self-development activity history, and the like of the promoted employees are analyzed to evaluate a career support record of the manager from multiple angles. For example, when 5 of the subordinate employees are promoted, 3 of them are experienced new project leaders, and 2 of them have acquired qualifications, the AI determines that “career support is actively provided”. The generative AI analysis unit predicts a possibility of ranking up within the next half year by using a performance evaluation score, a potential score, a business result, project leader experience, a self-development activity history, a training attendance history, a remark content on the internal SNS, a result of a health checkup or a stress check, and the like of the subordinate employee as input. For example, for an employee who has a high performance evaluation, is active in self-development activities, and has a good stress check result, the AI determines that “the possibility of promotion is high”, and reflects it in the evaluation of the career support record of the manager. Regarding bias detection of subordinate evaluation by the manager, the AI uses a statistical method or a clustering method to detect the presence or absence of a bias and calculate a bias score, for example, when a distribution of evaluation scores is extremely biased, or when there is an evaluation tendency biased toward a specific attribute (gender, age, job type, department of origin, etc.). For example, when a certain manager consistently gives a low evaluation to female employees, or gives a high evaluation to those from a specific department, the AI determines that “there is a bias risk”, and describes a specific evaluation tendency in the report. In the analysis of anonymous feedback, the generative AI uses a natural language processing technology to perform keyword and sentiment analysis such as “reliable”, “easy to consult”, “unfair”, “lack of support”, “insufficient explanation”, “evaluation is too strict”, and “little communication”, and extracts a reliability score and an improvement point list for each manager. For example, when there are many negative comments, the contents thereof are summarized, and a specific improvement proposal such as “lack of communication”, “bias in business load”, “unclear evaluation criteria”, and “inadequate support system” is automatically generated. Furthermore, a chronological change in the feedback is analyzed, and when the reliability score is in a downward trend, the AI determines that “early improvement intervention is necessary”, and notifies the manager and the human resources department through the alert notification unit. Specific examples of a prompt sentence necessary when executing the generative AI analysis unit include “Calculate a resignation rate, a transfer request rate, and a rank-up rate of subordinate employees of manager A for the past one year, perform bias detection and sentiment analysis of anonymous feedback, and extract a reliability score and an improvement point”, “Predict a possibility of ranking up within the next half year based on a performance evaluation score, a self-development activity history, and a stress check result of employee B”, “Analyze subordinate evaluation data of manager C for each attribute, detect the presence or absence of an evaluation bias, and calculate a bias score”, and “Analyze text data of anonymous feedback by natural language processing, summarize a negative opinion, and generate an improvement proposal”. Specifically, the generative AI analysis unit executes an inference pipeline that orchestrates a plurality of machine learning models. The generative AI analysis unit receives a multidimensional tensor extracted from the database management unit and a prompt text of a natural language as input data. Specific examples of the input data include a numerical matrix indicating a behavior history of the employee, and an instruction character string “Calculate a resignation rate of subordinate employees of manager A for the past one year, and perform bias detection”. The generative AI analysis unit converts this prompt text into a token sequence using a subword tokenizer. The generative AI analysis unit inputs this token sequence and the numerical tensor to a multimodal large language model. The large language model is based on a transformer architecture, and calculates a contextual dependency between tokens and between data using a self-attention mechanism. The large language model has billions of parameters, and is specialized in a personnel domain through pre-training and fine-tuning. The generative AI analysis unit generates structured text data and an array of prediction scores as an output. As a specific example of the output data, a character string of a key-value pair conforming to a JSON format is generated, and specific values such as a resignation rate of 15 percent, a bias score of 0.8, and an improvement proposal “resolution of lack of communication” are included therein. The generative AI analysis unit parses this output data and passes it to the subsequent evaluation report generation unit and alert notification unit. In the subsequent processing, the system renders a dynamic report based on this output data, and fires an alert by threshold determination. By this processing, the system seamlessly executes complex data analysis and natural language generation with a single model. The system instantly generates a natural and easy-to-understand analysis report as if written by a human. The system substitutes for a role of an advanced data scientist, and dramatically reduces analysis cost. As a specific application field, the system is applied as a system that automatically provides an analysis insight equivalent to that of a professional personnel consultant in a medium-sized company lacking a human resources department. The system flexibly responds to various analysis tasks in accordance with a user's intention by using a prompt engineering technology. The generative AI analysis unit also outputs an attention weight indicating which part of the input data is focused on as visualization data in order to show a basis of an inference result.

The evaluation report generation unit is a unit configured to automatically generate an evaluation report for each manager including the resignation rate, the transfer request rate, the rank-up rate, the bias detection result, the reliability score, the improvement point list, and the like obtained by the generative AI analysis unit. For example, specific numerical values and comments are described in the report, such as “the resignation rate in the past year is 15 percent”, “the transfer request rate is 5 percent”, “the promotion rate of subordinates is 20 percent”, “the bias score is low risk”, “the reliability score is 0.8”, “improvement point: improvement in communication frequency is necessary”, and “anonymous feedback: ‘generous support’, ‘strict evaluation’, ‘insufficient explanation’”. The report is automatically updated periodically or in real time, and is distributed from the server in a form viewable by the manager himself/herself, an upper-level manager, and a human resources department. For example, the report can be generated in various formats, such as a report automatically generated on a monthly basis, a temporary report at a specific event (such as when mass resignation occurs), a report for career review of an individual employee, and a cross-departmental comparison report. Specifically, the evaluation report generation unit executes a rendering pipeline that converts structured data output from the generative AI analysis unit into a visual document. The evaluation report generation unit receives a JSON object including the resignation rate, the transfer request rate, the rank-up rate, the bias detection result, the reliability score, and the improvement point list as input data. As a specific example of the input data, a current value of each index, past transition data, and an improvement proposal text described in natural language are included. The evaluation report generation unit pours this input data into a dynamic template engine described in HTML5 and CSS3. The evaluation report generation unit maps numerical data to properties of various chart components using a data binding technology. The evaluation report generation unit generates an interactive web page viewable by a browser or a PDF document for printing as an output. As a specific example of the output data, a report including a heat map in which strengths and weaknesses for each manager are color-coded and a line graph with animation indicating a change in chronological order is generated. The evaluation report generation unit distributes this output document to a subsequent report viewing unit, and displays the output document on a terminal of a designated user. In this subsequent processing, the system records a viewing log of the report, analyzes which section has been viewed the longest, and optimizes a next report configuration. By this processing, the system converts dry numerical data into an intuitively understandable storyboard. The system eliminates information asymmetry and enhances transparency within the organization. The system completely eliminates manual work required for report creation, and realizes real-time information sharing. As a specific application field, the system is applied to automatic generation of disclosure materials of human capital in a board of directors or a general meeting of shareholders. The system instantly provides an accurate and consistent report that can withstand an audit. The evaluation report generation unit includes a function of dynamically adjusting a granularity of information to be displayed in accordance with a position or authority of the user. The evaluation report generation unit highlights and displays, for example, a company-wide summary to a management layer and a specific action list to a manager in the field.

The alert notification unit is a unit configured to transmit an alert in real time to the manager, the human resources department, and the management layer when a serious risk for the organization is detected, such as when the resignation rate or the transfer request rate rapidly increases, when the reliability score rapidly decreases, or when the bias score is determined to be high risk. For example, a specific situation and a recommended action are notified, such as “the resignation rate of the subordinate employees has exceeded 20 percent in the past three months. Urgent action is required”, “many opinions that ‘evaluation is unfair’ have been received in the anonymous feedback. A review of evaluation criteria is recommended”, “the bias score is high risk. A reconsideration of an evaluation method is required”, and “the reliability score has fallen below 0.4. Strengthening of communication is recommended”. Specifically, the alert notification unit adopts an event-driven asynchronous processing architecture. The alert notification unit receives an anomaly detection signal from each module via a message queuing system. The alert notification unit evaluates the received signal as a multidimensional vector. The alert notification unit executes a threshold determination algorithm. The alert notification unit reduces false detection using a dynamic threshold. The alert notification unit calculates a priority of the notification. The alert notification unit dynamically switches a communication protocol in accordance with the priority. The alert notification unit optimizes consumption of a network bandwidth. The alert notification unit ensures real-time performance. The alert notification unit cooperates with a push notification server. The alert notification unit generates a payload in a structured data format. The alert notification unit encrypts and transmits the payload. The alert notification unit monitors an acknowledgment response. The alert notification unit executes a retransmission control algorithm. The alert notification unit improves reliability of communication. The alert notification unit enhances availability of the entire system. The alert notification unit brings about a technical effect of early discovery of a personnel risk. The alert notification unit is particularly effective in a large-scale corporate network environment.

The user interface unit is a unit for each user, such as the manager, the employee, and a human resources staff member, to access the server through a browser or a dedicated application, and perform viewing of the evaluation report, posting of the feedback, execution of the review session, confirmation of the improvement proposal, and the like. For example, the manager can confirm his/her own evaluation report, grasp the reliability score and the improvement point, and review a management behavior. The employee can post the feedback anonymously, and confirm a past feedback history and his/her own career growth status. The human resources staff member can grasp the evaluation tendency and a bias risk of the entire organization, and utilize them as evidence for system improvement. For example, various interfaces are provided, such as a screen for displaying a list of main indexes in a dashboard format, a detailed display screen of an individual report, a feedback posting screen, and an agenda display screen for the review session. Specifically, the user interface unit adopts a single-page application architecture. The user interface unit speeds up screen drawing using a virtual document object model. The user interface unit communicates with the server via an application programming interface. The user interface unit transmits and receives an object in a structured data format. The user interface unit utilizes an asynchronous communication protocol. The user interface unit conceals a network delay. The user interface unit constructs a state management store on a memory on a client side. The user interface unit detects a change in state and dynamically re-renders a screen component. The user interface unit applies the data binding technology. The user interface unit shortens a response time to a user operation. The user interface unit utilizes hardware acceleration of a graphics processing unit. The user interface unit smoothly draws a complex data visualization component. The user interface unit dynamically changes a layout in accordance with a screen size of a device. The user interface unit implements a responsive design. The user interface unit brings about a technical effect of reducing a cognitive load of the user. The user interface unit is widely applied in an enterprise environment in which various terminals are mixed.

The feedback input unit is a unit configured to provide an interface through which the employee can anonymously post the feedback to the manager. For example, a plurality of questions and a free description field are provided, such as “about a support system of a boss”, “about fairness of evaluation”, and “about frequency of communication”, so that the employee can post a frank opinion. The posted feedback is immediately transmitted to the server, and is analyzed by the generative AI analysis unit. For example, a device for enhancing psychological safety of the employee is applied, such as an input screen combining a multiple-choice question and a free description, a confirmation screen of a past posting history, and an automatic response message display after posting the feedback. Specifically, the feedback input unit implements a secure data transmission protocol. The feedback input unit encrypts input text data on the client side. The feedback input unit adopts a public key cryptography method. The feedback input unit prevents a man-in-the-middle attack. The feedback input unit manages each field of an input form as an independent component. The feedback input unit counts the number of input characters in real time. The feedback input unit executes a validation process of input content on the client side. The feedback input unit prevents transmission of an invalid request to the server. The feedback input unit saves the network bandwidth. The feedback input unit serializes the input data into a payload in a structured data format. The feedback input unit transmits the payload to the server using asynchronous communication. The feedback input unit deletes local cache data after completion of transmission. The feedback input unit prevents confidential information from remaining on the terminal. The feedback input unit technically ensures anonymity. The feedback input unit irreversibly converts a user identifier using a hash function. The feedback input unit verifies integrity of data. The feedback input unit brings about a technical effect of reducing an information leakage risk. The feedback input unit is particularly useful in a financial institution or a medical institution with strict compliance requirements.

The report viewing unit is a unit configured to provide an interface through which the manager and the human resources staff member can view the evaluation report distributed from the server. For example, information is displayed in a visually easy-to-understand format, such as a transition graph of the resignation rate in the past year, a chronological change of the transfer request rate, a list of the rank-up record, a heat map of the bias detection result, a transition graph of the reliability score, and details of the improvement point list. For example, various display formats such as a graph, a chart, a heat map, a text summary, and a comparison table are used. Specifically, the report viewing unit is equipped with a dedicated rendering engine for data visualization. The report viewing unit analyzes a multidimensional data array received from the server. The report viewing unit converts the data array into vertex data for graphics drawing. The report viewing unit calls a web-standard graphics application programming interface. The report viewing unit parallelizes a drawing process using the graphics processing unit of the client terminal. The report viewing unit draws a scatter plot or a heat map including tens of thousands of data points in milliseconds. The report viewing unit detects a scroll or zoom operation by the user. The report viewing unit dynamically recalculates data in a display area in accordance with an operation event. The report viewing unit executes a level-of-detail control algorithm. The report viewing unit adjusts a degree of data aggregation in accordance with a display magnification. The report viewing unit keeps a drawing load constant. The report viewing unit optimizes garbage collection for preventing a memory leak. The report viewing unit guarantees a stable operation even in a long-time viewing session. The report viewing unit brings about a technical effect of enabling intuitive grasping of a large amount of data. The report viewing unit is extremely effective in a dashboard system in which the management layer overlooks a situation of the entire organization.

The review session support unit is a unit configured to support the manager and the subordinate employee to formulate a specific action plan while referring to the evaluation report, the feedback history, the improvement proposal by AI, and the like when periodically conducting the review session. For example, an agenda and an action list automatically generated by AI, such as “factor analysis of an increase in the resignation rate in this term”, “background of a decrease in the reliability score”, and “specific measure for strengthening career support”, are presented to improve quality of the review session. For example, a function of automatically listing agendas before the session, a function of displaying a past improvement action and its effect in chronological order, a function of recording a memo and an action plan in real time during the session, a function of automatically notifying a follow-up task after the session, and the like are provided. Specifically, the review session support unit implements a real-time synchronous communication protocol. The review session support unit establishes a WebSocket connection. The review session support unit synchronizes a state among a plurality of client terminals in milliseconds. The review session support unit executes an exclusive control algorithm. The review session support unit prevents data conflict due to simultaneous editing. The review session support unit records an operation history as a chronological transaction log. The review session support unit transmits only difference data via a network. The review session support unit minimizes a communication data amount. The review session support unit executes a natural language processing model in the background. The review session support unit analyzes input memo text in real time. The review session support unit applies a keyword extraction algorithm. The review session support unit searches the database for a related past action plan based on the extracted keyword. The review session support unit dynamically displays a search result on a screen as a recommendation list. The review session support unit reduces an input load of the user. The review session support unit extracts all action items as structured data at the end of the session. The review session support unit automatically registers the action items in a task management database. The review session support unit brings about a technical effect of realizing seamless linkage of business processes. The review session support unit is particularly effective in an online interview under a remote work environment.

In this way, the system according to the present embodiment realizes data collection, data management, AI analysis, report generation, alert notification, user interface, feedback input, report viewing, and review session support by cooperation of each unit, enhances fairness, transparency, and objectivity of personnel evaluation with generative AI at the core, and realizes improvement in reliability and performance of the entire organization. Specifically, the system operates on a distributed processing infrastructure based on a microservices architecture. The system deploys each unit as an independent container. The system dynamically allocates resources using a container orchestration tool. The system automatically increases or decreases the number of instances of each module in accordance with a load situation. The system executes an auto-scaling function. The system optimizes processing capacity of the entire system. The system introduces a service mesh technology for communication between modules. The system transparently performs encryption and authentication of communication. The system realizes a zero-trust network security model. The system eliminates a single point of failure. The system ensures high availability. The system offloads an inference process of a generative artificial intelligence model to a dedicated hardware accelerator. The system reduces a load on a central processing unit. The system improves a response speed of the entire system. The system brings about a technical effect of automating and sophisticating a data-driven personnel evaluation process by computer technology. The system is extremely useful in a use case of simultaneously achieving standardization and efficiency of evaluation in a global company having tens of thousands of employees.

### (Implementation Steps)

Step 1: Comprehensive Collection of Personnel-Related Data In this step, the data collection unit automatically and periodically collects data regarding the manager and the subordinate employees from various information sources inside and outside the organization. Specifically, basic information of the employee, a resignation date, a transfer request application date, presence or absence of a job change activity, a rank-up record, a performance evaluation score, and a potential score are acquired from the personnel management system, and a project participation history and a submission status of a business deliverable are acquired from the business management system. Furthermore, a status of lateness, early departure, overtime work, and paid leave acquisition is collected from the attendance management system, a training attendance history and a qualification acquisition status are collected from the training management system, and the number of times and content of remarks, and the number of transmissions and receptions are collected from the internal SNS and the email system. In addition, a result of a 360-degree evaluation, a feedback comment by free description, a health checkup result, and a stress check result are acquired from the anonymous feedback system and the employee questionnaire system, and multifaceted and comprehensive information regarding the subordinate employees of the manager is accumulated. For example, detailed data can be acquired, such as that a certain employee has submitted a transfer request twice in the past year, attended training three times, experienced a project leader once, and made remarks on the internal SNS 30 times a month on average. Specifically, the data collection unit executes a distributed crawler engine. The data collection unit issues a connection request in parallel to a plurality of external systems. The data collection unit dynamically generates a request header in accordance with a specification of an application programming interface of each system. The data collection unit securely manages an authentication token. The data collection unit applies a rate limit control algorithm. The data collection unit prevents an excessive load on the external system. The data collection unit stores acquired raw data in a temporary in-memory data grid. The data collection unit executes a data cleansing process. The data collection unit performs complementation of a missing value and removal of an abnormal value. The data collection unit applies a normalization algorithm for unifying a data format. The data collection unit deletes a control character and a hypertext markup language tag that become noise from unstructured text data. The data collection unit converts the extracted data into a document in a structured data format. The data collection unit assigns a time stamp and a unique identifier to the converted document. The data collection unit publishes the document to a message queue for transferring the data to a subsequent processing module. The data collection unit automates pipeline processing from data collection to normalization. The data collection unit brings about a technical effect of significantly shortening a calculation time required for data preparation. The data collection unit becomes an indispensable fundamental technology in promoting digital transformation of a company in which various legacy systems are mixed.
Step 2: Chronological Storage and Management in Database In this step, the database management unit organizes the various data collected in the previous step in chronological order, and manages the data so that the data can be searched, extracted, and aggregated from various perspectives such as for each manager, for each employee, for each department, and for each project. For example, a data infrastructure for detailed analysis is constructed, such as a transition of the resignation rate of the subordinate employees of a specific manager in the past three years, a year-by-year comparison of the transfer request rate of a certain department, a distribution of the performance evaluation of members in a specific project, a career path history for each employee, visualization of cross-departmental human resource liquidity, a chronological change of the anonymous feedback, and a correlation analysis between the training attendance history and a promotion record. Specifically, the database management unit adopts a distributed column-oriented database system. The database management unit implements a log-structured merge-tree for maximizing write performance of chronological data. The database management unit temporarily holds received data in a buffer on a memory. The database management unit flushes the data as an immutable data file on a disk when the buffer reaches a certain size. The database management unit executes a compaction process of the data file in the background. The database management unit optimizes read performance. The database management unit physically arranges data as an independent column for each data attribute. The database management unit reads only a necessary column from the disk when executing an aggregation query for a specific attribute. The database management unit dramatically reduces consumption of a disk input/output bandwidth. The database management unit optimizes and applies a data compression algorithm for each column. The database management unit uses run-length encoding or dictionary compression. The database management unit saves a storage capacity. The database management unit constructs a multidimensional index structure. The database management unit maps multidimensional data to a one-dimensional space using a space-filling curve. The database management unit processes a complex range search query at high speed. The database management unit brings about a technical effect of shortening a response time of an analysis query for a large-scale data set to the order of milliseconds. The database management unit is extremely effective as a back end of a management dashboard requiring real-time decision making.
Step 3: Multidimensional Analysis of Personnel Data by Generative AI In this step, the generative AI analysis unit executes various AI analyses using the data accumulated in the database management unit. First, the resignation rate and the transfer request rate of the subordinate employees for each manager are calculated, and for example, the number of employees who resigned or the number of employees who submitted a transfer request in the past year is aggregated and divided by the total number of subordinate employees to obtain a quantitative index. Next, regarding the rank-up record of subordinates, the number of employees promoted and a promotion rate in the past two years are calculated, and the performance evaluation score, project leader experience, self-development activity history, and the like of the promoted employees are analyzed to evaluate a career support record of the manager from multiple angles. Furthermore, using the performance evaluation score, the potential score, business results, project leader experience, self-development activity history, training attendance history, utterance contents on the internal SNS, results of health checkups and stress checks, and the like of the subordinate employees as input, a future rank-up possibility within the next half year is predicted. Regarding bias detection of subordinate evaluation by the manager, the AI detects the presence or absence of a subjective bias and calculates a bias score using a statistical method or a clustering method when the distribution of evaluation scores is extremely biased or when there is an evaluation tendency biased toward a specific attribute (gender, age, job type, department of origin, etc.). In the analysis of the anonymous feedback, the generative AI performs keyword and sentiment analysis, such as “reliable”, “easy to consult”, “unfair”, “lack of support”, “insufficient explanation”, “too strict evaluation”, and “little communication”, using a natural language processing technology, and extracts a reliability score and an improvement point list for each manager. Specific examples of prompt sentences to be read by the generative AI include “Calculate the resignation rate, the transfer request rate, and the rank-up rate of the subordinate employees of the manager A in the past year, perform bias detection and sentiment analysis of the anonymous feedback, and extract a reliability score and improvement points”, “Predict a future rank-up possibility within the next half year based on the performance evaluation score, self-development activity history, and stress check result of the employee B”, “Analyze subordinate evaluation data of the manager C for each attribute, detect the presence or absence of an evaluation bias, and calculate a bias score”, and “Analyze text data of the anonymous feedback by natural language processing, summarize negative opinions, and generate an improvement proposal”. Specifically, the generative AI analysis unit executes an ensemble learning architecture integrating a plurality of neural network models. The generative AI analysis unit receives a multidimensional numerical vector including attribute information, evaluation history, and an action log of the employee as input data. For example, the input vector is a 128-dimensional tensor including age, years of service, past three evaluation scores, monthly average overtime hours, the number of utterances on the internal network, and the like. The generative AI analysis unit normalizes this input tensor and performs preprocessing to complement missing values with an average value. The generative AI analysis unit inputs the preprocessed tensor to a deep learning model. The deep learning model is a multilayer perceptron composed of a plurality of fully connected layers and dropout layers. The deep learning model applies a non-linear activation function in each layer to extract a complex interaction of feature amounts in a high-dimensional space. The deep learning model generates a continuous value score between 0 and 1 indicating a rank-up probability within the next half year as an output. For example, if the output score is 0.85, it means that the possibility of rank-up is extremely high. The generative AI analysis unit passes this output score to a threshold determination module, and assigns a label of a promotion candidate if the score is 0.7 or more. In addition, the generative AI analysis unit executes a large language model based on a transformer architecture for a natural language processing task. An input to the large language model is a sequence of word embedding vectors obtained by tokenizing text data of the anonymous feedback and adding positional encoding. For example, the input data is obtained by converting a text that evaluation criteria are unclear and motivation is lowered into a 512-dimensional vector sequence. The large language model calculates a context dependency using a self-attention mechanism. The large language model generates structured data including a sentiment polarity score and an extracted improvement keyword as an output. For example, the output data includes a score of a negative degree of 0.9 and a keyword of clarification of evaluation criteria. The generative AI analysis unit transfers this output data to the evaluation report generation unit. The generative AI analysis unit periodically relearns weight parameters of the model using an error backpropagation method. The generative AI analysis unit executes an optimization algorithm so as to minimize a cross-entropy error function. The generative AI analysis unit brings about a technical effect of realizing pattern recognition of high-dimensional data exceeding human cognitive ability. The generative AI analysis unit plays a core role in a use case of eliminating subjective evaluation and realizing data-driven objective personnel evaluation.
Step 4: Automatic Generation and Distribution of Evaluation Report In this step, the evaluation report generation unit automatically generates an evaluation report for each manager including the resignation rate, the transfer request rate, the rank-up rate, the bias detection result, the reliability score, the improvement point list, and the like obtained by the generative AI analysis unit. For example, specific numerical values and comments such as “resignation rate in the past year is 15 percent”, “transfer request rate is 5 percent”, “promotion rate of subordinates is 20 percent”, “bias score is low risk”, “reliability score is 0.8”, “improvement point: improvement in communication frequency is necessary”, and “anonymous feedback: ‘generous support’, ‘strict evaluation’, ‘insufficient explanation’” are described in the report. The report is automatically updated periodically or in real time, and is distributed from the server in a form viewable by the manager himself/herself, the upper-level manager, and the human resources department. For example, the report can be generated in various formats, such as a report automatically generated on a monthly basis, a temporary report at a specific event (such as when mass resignation occurs), a report for career review of an individual employee, and a cross-departmental comparison report. Specifically, the evaluation report generation unit executes a dynamic document generation algorithm integrating a template engine and a data binding mechanism. The evaluation report generation unit receives analysis result data in a structured data format output from the generative AI analysis unit. The evaluation report generation unit maps this data to a virtual object tree on a memory. The evaluation report generation unit reads a predefined report template from a storage. The evaluation report generation unit replaces a placeholder in the template with a value of a corresponding data node of the virtual object tree. The evaluation report generation unit executes a conditional branching logic. When the bias score exceeds a specific threshold, the evaluation report generation unit dynamically inserts a special visual component for warning into the report. The evaluation report generation unit calls a graph drawing library for visualizing numerical data. The evaluation report generation unit generates a chart image in a vector graphics format on the memory using time-series data as an input. The evaluation report generation unit embeds the generated image data into a report document. The evaluation report generation unit serializes the final document into a portable document format or a hypertext markup language format. The evaluation report generation unit saves the generated file in a distributed file system. The evaluation report generation unit records a universal resource locator indicating a storage location of the file in the database. The evaluation report generation unit sets an access control list. The evaluation report generation unit blocks access from an unauthorized user by an encryption technology. The evaluation report generation unit brings about a technical effect of dramatically reducing calculation resources and time required for report creation. The evaluation report generation unit is extremely effective in a large-scale enterprise environment that simultaneously provides individualized feedback to thousands of managers.
Step 5: Early Detection and Response to Risk by Alert Notification In this step, the alert notification unit transmits an alert in real time to the manager, the human resources department, and the management layer when a serious risk for the organization is detected, such as when the resignation rate or the transfer request rate rapidly increases, when the reliability score rapidly decreases, or when the bias score is determined to be high risk. For example, a specific situation and a recommended action are notified, such as “The resignation rate of subordinate employees has exceeded 20 percent in the past three months. Urgent response is required”, “Many opinions that ‘evaluation is unfair’ have been received in the anonymous feedback. Review of evaluation criteria is recommended”, “The bias score is high risk. Re-examination of the evaluation method is required”, and “The reliability score has fallen below 0.4. Strengthening of communication is recommended”. Specifically, the alert notification unit implements a complex event processing engine. The alert notification unit monitors a data stream continuously output from the database management unit and the generative AI analysis unit. The alert notification unit applies a sliding window algorithm. The alert notification unit holds data points within a recent certain period on a memory. The alert notification unit executes a statistical anomaly detection algorithm on the data in this window. The alert notification unit calculates a moving average and a standard deviation in real time. The alert notification unit sets an anomaly flag when a current value deviates from a statistical normal range. The alert notification unit evaluates a complex rule set in which a plurality of anomaly flags are combined by a logical operator. The alert notification unit generates an alert object when the rule is met. The alert notification unit adds an importance level, an occurrence time, an identifier of a related manager, and text data of a recommended action to this alert object. The alert notification unit transmits the generated alert object to a message broker. The alert notification unit uses a publish-subscribe model of the message broker. The alert notification unit asynchronously distributes a push notification to a terminal of an appropriate receiver. The alert notification unit executes a retransmission control mechanism to ensure certainty of distribution. When a reception confirmation is not obtained within a certain time, the alert notification unit switches to an alternative communication channel and retransmits. The alert notification unit brings about a technical effect of detecting a potential risk of the organization before it becomes apparent and enabling a prompt response. The alert notification unit functions as an early warning system for minimizing risks of compliance violation and mass resignation.
Step 6: Visualization and Utilization of Information by User Interface In this step, the user interface unit provides an interface for each user, such as the manager, the employee, and a human resources person in charge, to access the server through a browser or a dedicated application, and perform viewing of the evaluation report, posting of feedback, execution of a review session, confirmation of an improvement proposal, and the like. For example, the manager can check his/her own evaluation report, grasp the reliability score and the improvement point, and review management behavior. The employee can post feedback anonymously, and check a past feedback history and his/her own career growth status. The human resources person in charge can grasp the evaluation tendency and the bias risk of the entire organization, and utilize them as evidence for system improvement. Specifically, the user interface unit is implemented as a single-page application operating on a web browser of a client terminal. The user interface unit optimizes redrawing of a screen using a virtual document object model technology. The user interface unit receives data in a structured data format from the server via an asynchronous communication protocol. The user interface unit stores the received data in a state management container on the client side. The user interface unit detects a change in state and differentially updates only a related screen component. The user interface unit eliminates reloading of the entire screen. The user interface unit suppresses a response delay to a user operation to a millisecond unit. The user interface unit enables hardware acceleration of a graphics processing unit. The user interface unit smoothly renders a complex animation and a data visualization component. The user interface unit follows a principle of responsive web design. The user interface unit dynamically acquires a screen resolution and an aspect ratio of the terminal. The user interface unit recalculates a layout grid based on the acquired parameters. The user interface unit provides an optimal display on various devices such as a smartphone, a tablet, and a desktop terminal. The user interface unit brings about a technical effect of reducing a cognitive load of the user and improving a degree of understanding of information. The user interface unit plays an extremely important role in an internal portal system routinely used by various employees with different information technology literacy.
Step 7: Posting of Feedback and Execution of Review Session In this step, the feedback input unit receives posting of the anonymous feedback by the employee, and the review session support unit supports the manager and the subordinate employee to formulate a specific action plan while referring to the evaluation report, the feedback history, the improvement proposal by the AI, and the like when periodically executing the review session. For example, a function of automatically listing agenda items before the session, a function of displaying past improvement actions and their effects in chronological order, a function of recording a memo and an action plan in real time during the session, a function of automatically notifying a follow-up task after the session, and the like are provided. Specifically, the feedback input unit executes a real-time sanitization process on the input text data on the client side. The feedback input unit escapes a special character to prevent a cross-site scripting attack. The feedback input unit encrypts the data by a public key cryptosystem and then transmits the data to the server. The feedback input unit prevents eavesdropping on a communication path. The review session support unit executes a WebSocket server on the server side. The review session support unit establishes a bidirectional real-time communication channel between the terminals of the manager and the employee. The review session support unit implements an operational transformation algorithm. The review session support unit automatically resolves data conflict during simultaneous editing by a plurality of users. The review session support unit inputs text data recorded during the session to a natural language processing model in the background. The review session support unit automatically extracts a candidate for an action item from the text using this model. The review session support unit push-transmits the extracted candidate as structured data to the client terminal. The review session support unit dynamically displays the candidate as a recommendation list on the screen of the client terminal. The review session support unit inserts the action plan finalized at the end of the session into a task management table of a relational database. The review session support unit schedules a reminder notification based on a designated date. The review session support unit brings about a technical effect of digitizing an interview process and enhancing certainty of follow-up. The review session support unit is optimal for a use case of improving convincingness and execution capability of evaluation in a company operating a management by objectives system.

### (Specific Use Case)

For example, a case is assumed where a department head conducts personnel evaluation of subordinate employees in a technical department within an organization. In this case, the data collection unit automatically acquires a resignation date, a transfer request application date, presence or absence of job change activity, a past rank-up record, a performance evaluation score, and a potential score of the subordinate employees from a personnel management system of the technical department. Furthermore, a project participation history, leader experience, and a submission status of business deliverables of each employee are collected from a project management system, and attendance data such as lateness, early departure, overtime, and paid leave acquisition status is acquired from an attendance management system. In addition, a training attendance history and a qualification acquisition status are collected from a training management system, the number of utterances and contents are collected from an internal SNS, the number of transmissions and receptions is collected from an email system, and a free-description feedback comment by the employee and a result of 360-degree evaluation are collected from an anonymous feedback system. These data are organized in chronological order by the database management unit, and are managed in a state where they can be searched, extracted, and aggregated for each department head, for each employee, and for each project. Specifically, the data collection unit executes a dedicated connector group for corresponding to various data sources peculiar to the technical department. The data collection unit calls an application programming interface of a source code management system. The data collection unit acquires development activity data such as the number of commits, the number of created pull requests, and the number of executed code reviews of each employee in a structured data format. The data collection unit analyzes a log file of a continuous integration system. The data collection unit extracts a transition of a build success rate and test coverage as numerical data. The data collection unit acquires a bug resolution time and a severity level of a handled failure from a failure management system. The data collection unit reads these unstructured and semi-structured data into a data frame on a memory. The data collection unit executes a cast process for unifying data types. The data collection unit normalizes a time zone difference to coordinated universal time. The data collection unit joins a plurality of data frames using a unique identifier of the employee as a key. The data collection unit converts the joined data into a multidimensional time-series tensor. The data collection unit bulk-inserts this tensor into a distributed column-oriented database. The data collection unit asynchronously rebuilds an index of the database. The data collection unit optimizes an execution speed of a subsequent search query. The data collection unit brings about a technical effect of automatically constructing a data infrastructure for quantifying productivity and contribution of an engineer. The data collection unit is indispensable for realizing objective performance evaluation in a software development organization adopting agile development.

The generative AI analysis unit calculates the resignation rate, the transfer request rate, and the rank-up rate of the subordinate employees for each department head using these data, and outputs a quantitative index such as “Since 3 out of 20 subordinate employees of the department head A resigned and 2 submitted a transfer request in the past year, the resignation rate is 15 percent and the transfer request rate is 10 percent”, for example. Furthermore, using the performance evaluation score, the potential score, project leader experience, self-development activity history, training attendance history, utterance contents on the internal SNS, results of health checkups and stress checks, and the like of the subordinate employees as input, a future rank-up possibility within the next half year is predicted, and it is determined that “Employee C, who has a high performance evaluation, is active in self-development activities, and has a good stress check result, has a high possibility of promotion”. Regarding bias detection of subordinate evaluation by the department head, the AI detects a bias risk such as “Department head A consistently gives low evaluations to female employees” or “Gives high evaluations to those from a specific department” using a statistical method or a clustering method, and calculates a bias score. In the analysis of the anonymous feedback, the generative AI performs keyword and sentiment analysis, such as “reliable”, “easy to consult”, “unfair”, “lack of support”, “insufficient explanation”, “too strict evaluation”, and “little communication”, using the natural language processing technology, and extracts a reliability score and an improvement point list for each department head. Specifically, the generative AI analysis unit executes a multimodal neural network optimized for data characteristics of the technical department. The generative AI analysis unit receives composite data including a commit history, a text of a code review, and a performance evaluation score of the employee as input data. For example, the input data is a 64-dimensional vector composed of numerical data and a sequence of 512-dimensional word embedding vectors obtained by tokenizing a comment of the code review. The generative AI analysis unit processes this input data by a fully connected layer and a transformer encoder, respectively. The generative AI analysis unit integrates output feature maps of both by a concatenation layer. The generative AI analysis unit inputs the integrated feature vector to a classifier having a plurality of hidden layers. The classifier generates a score indicating a rank-up probability within the next half year and a probability distribution indicating a turnover risk as an output. For example, the output score is 0.92, and the probability distribution is 80 percent low risk and 20 percent high risk. The generative AI analysis unit passes this output score to a threshold determination module, and sets a promotion candidate flag if the rank-up probability is 0.8 or more. In addition, the generative AI analysis unit executes a density-based spatial clustering algorithm of unsupervised learning in order to detect an evaluation bias by the department head. The generative AI analysis unit plots evaluation data and employee attributes in a high-dimensional space, and detects a cluster in which evaluation for a specific attribute is statistically significantly low. The generative AI analysis unit calculates a bias score based on this detection result. The generative AI analysis unit analyzes the anonymous feedback using a natural language processing model, and outputs a sentiment polarity score and a topic classification label. The generative AI analysis unit organizes these output results in a structured data format, and transfers them to the evaluation report generation unit. The generative AI analysis unit brings about a technical effect of discovering a complex correlation that cannot be captured by human intuition by calculation in a high-dimensional space. The generative AI analysis unit is extremely effective in a use case of establishing a highly fair and transparent evaluation criterion in a technical department where expertise is high and evaluation is likely to be personalized.

Based on these analysis results, the evaluation report generation unit automatically generates an evaluation report including specific numerical values and comments such as “resignation rate of department head A in the past year is 15 percent, transfer request rate is 10 percent, promotion rate of subordinates is 20 percent, bias score is high risk, reliability score is 0.6, improvement point: improvement in communication frequency is necessary, anonymous feedback: ‘generous support’, ‘strict evaluation’, ‘insufficient explanation’”, and distributes the evaluation report to the department head himself/herself, the upper-level manager, and the human resources department periodically or in real time. The alert notification unit transmits an alert in real time to the department head, the human resources department, and the management layer when a serious risk is detected, such as “The resignation rate of subordinate employees of department head A has exceeded 20 percent in the past three months”, “Many opinions that ‘evaluation is unfair’ have been received in the anonymous feedback”, “The bias score is high risk”, and “The reliability score has fallen below 0.4”, for example. Specifically, the evaluation report generation unit receives the structured data output from the generative AI analysis unit as an input. The evaluation report generation unit maps this data to a virtual document object model on a memory. The evaluation report generation unit reads a dedicated template for the technical department from a storage. The evaluation report generation unit dynamically replaces a variable placeholder in the template with the mapped data. The evaluation report generation unit executes a data visualization library. The evaluation report generation unit renders a radar chart indicating a distribution of the bias score and a line graph indicating a transition of the resignation rate as vector graphics on the memory. The evaluation report generation unit embeds the rendered image data inline in the document. The evaluation report generation unit converts the completed document into a portable document format, encrypts it, and saves it in a distributed file system. The alert notification unit monitors metadata of the generated report. The alert notification unit detects that the bias score exceeds a preset threshold. The alert notification unit generates an emergency alert message using this detection event as a trigger. The alert notification unit asynchronously transmits a push notification to the terminals of the department head and the human resources department via a message queuing system. The alert notification unit records a transmission log in a database and tracks a reception confirmation. The alert notification unit brings about a technical effect of minimizing latency from generation to transmission of information. The alert notification unit supports proactive management for preventing a risk of human resource outflow of a specific skill in the technical department.

The user interface unit enables the department head to check his/her own evaluation report, grasp the reliability score and the improvement point, and review management behavior, and the employee can post feedback anonymously, and check a past feedback history and his/her own career growth status. The human resources person in charge can grasp the evaluation tendency and the bias risk of the entire organization, and utilize them as evidence for system improvement. The feedback input unit enables the employee to post a frank opinion using a plurality of questions and a free description column, such as “about support system of boss”, “about fairness of evaluation”, and “about frequency of communication”, and the posted feedback is immediately transmitted to the server and analyzed by the generative AI analysis unit. The report viewing unit provides an interface allowing the department head and the human resources person in charge to view the evaluation report distributed from the server, and displays a transition graph of the resignation rate in the past year, a time-series change of the transfer request rate, a list of the rank-up record, a heat map of the bias detection result, a transition graph of the reliability score, details of the improvement point list, and the like in a visually easy-to-understand format. The review session support unit supports the department head and the subordinate employee to formulate a specific action plan while referring to the evaluation report, the feedback history, the improvement proposal by the AI, and the like when periodically executing the review session. Specifically, the user interface unit executes advanced data processing on the client terminal using a WebAssembly technology. The user interface unit caches large-scale evaluation data received from the server in a memory on the client side. The user interface unit recalculates data locally without communicating with the server in response to a filtering operation by the user. The user interface unit completes redrawing of a screen in a millisecond unit. The feedback input unit executes a real-time input verification algorithm for each field of an input form. The feedback input unit blocks mixing of an invalid character code or a script tag on the client side. The feedback input unit serializes the input data into a structured data payload, and safely transmits it to the server using a transport layer security protocol. The report viewing unit dynamically renders a heat map of the bias detection result using a graphics processing unit of the client terminal. The report viewing unit immediately displays a detailed tooltip in response to a hover operation by the user. The review session support unit implements a web real-time communication protocol. The review session support unit encrypts and transmits/receives an audio and video stream peer-to-peer between the terminals of the department head and the employee. The review session support unit converts audio during the session into text in the background. The review session support unit automatically extracts an action item from the text using a natural language processing model, and reflects it in a shared editor on the screen in real time. The review session support unit brings about a technical effect of dramatically reducing an operation load of the user and improving quality of communication. The review session support unit is optimal for a use case of realizing an effective online meeting in a technical department where remote work is central.

Specific examples of prompt sentences to be read by the generative AI include “Calculate a resignation rate, a transfer request rate, and a rank-up rate of subordinate employees of a department head A for the past one year, perform bias detection and sentiment analysis of anonymous feedback, and extract a reliability score and an improvement point”, “Predict a future rank-up possibility within the next half year based on a performance evaluation score, a self-development activity history, and a stress check result of an employee B”, “Analyze subordinate evaluation data of a department head C for each attribute, detect presence or absence of an evaluation bias, and calculate a bias score”, and “Analyze text data of anonymous feedback by natural language processing, summarize a negative opinion, and generate an improvement proposal”. Specifically, the system implements a prompt engineering module. The prompt engineering module dynamically embeds structured data extracted from a database into a natural language prompt template. The prompt engineering module optimizes a text length in accordance with a limitation of an input context window of a large language model. The prompt engineering module executes a tokenization algorithm. The prompt engineering module converts an input text into an array of subword tokens. For example, input data is a 1024-dimensional token array including a text “Calculate a resignation rate of subordinate employees of a department head A for the past one year and extract an improvement point”. The prompt engineering module transmits the token array to an inference engine of the large language model. The inference engine highly parallelizes a matrix multiplication operation using a tensor core of a graphics processing unit. The inference engine accelerates calculation of a self-attention mechanism. The inference engine generates a structured text including a requested analysis result as an output. For example, output data is a structured text having a resignation rate, a bias score, and an improvement point as keys, and having character strings of 0.15, 0.8, and an increase in feedback frequency as respective values. The prompt engineering module parses the output text and converts the output text into a data object processable by a subsequent evaluation report generation unit. The prompt engineering module executes an error handling logic. The prompt engineering module automatically regenerates a prompt and retries when an output format is invalid. The prompt engineering module brings about a technical effect of reliably integrating an output of the generative artificial intelligence into a deterministic system process. The prompt engineering module automates a complex analysis task and serves as a fundamental technology for improving accuracy of personnel evaluation.

In this way, by using the system of the present invention, in personnel evaluation of a department head, it is possible to break away from conventional subjective and personal evaluation, objectively and quantitatively visualize a resignation rate, a transfer request rate, a rank-up rate, bias detection, a reliability score, an improvement point, and the like, and significantly improve fairness, transparency, and reliability of the entire organization through an evaluation report, an alert notification, and review session support. Specifically, the system executes a pipeline processing architecture integrating the above-described modules. The system automatically controls a data flow from data collection to analysis, report generation, and notification in an event-driven manner. The system asynchronously passes data between respective processing steps via a message queue on a memory. The system minimizes disk input/output and maximizes throughput of the entire system. The system temporarily stores an inference result of a machine learning model in a cache memory. The system omits recalculation for the same input and shortens a response time. The system continuously transfers a system log to a centralized log management server. The system monitors an operating status and an error occurrence rate of the system in real time. The system executes an automatic recovery script upon anomaly detection. The system minimizes a downtime of the system. The system converts conventional personnel work depending on human subjective judgment into a data-driven and algorithm-based objective process. The system brings about a technical effect of mathematically reducing variation in evaluation and optimizing performance of the entire organization. The system exhibits extremely high usefulness in a use case of providing a fair and highly transparent personnel evaluation infrastructure in a modern corporate environment where employees having diverse values coexist.

### Application Example 1

The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

An embodiment of the present invention will be described more specifically and in detail by taking a manager evaluation system in a nursing care site as an example. The system is composed of a server and a terminal, and includes a data collection unit, a generative AI analysis unit, an evaluation report generation unit, a database management unit, and an alert notification unit on the server side, and includes a user interface unit, a feedback input unit, a report viewing unit, and a review session support unit on the terminal side.

The data collection unit automatically and periodically collects data regarding a manager and subordinate staff from diverse information sources inside and outside a nursing care facility. For example, an employment date, a resignation date, a transfer request, a reassignment history, a training attendance history, a qualification acquisition status, years of service, a past evaluation score, a promotion history, a reward and punishment history, and the like are acquired from a personnel management system for nursing care staff. From a care recording system, a care plan achievement rate, a daily care record, care content for each user, a care implementation frequency, details of the care content (for example, meal assistance, bathing assistance, excretion assistance, rehabilitation support, recreation implementation status, and the like), a user satisfaction questionnaire result, a care satisfaction score for each user, a record of direct gratitude and complaints from the user, and the like are acquired. From an accident/near-miss reporting system, the number of incident occurrences, an occurrence date and time, an occurrence location, an occurrence cause, response content, a recurrence prevention measure, involved staff, an incident severity classification (minor, moderate, severe), a follow-up status after the incident occurrence, and the like are acquired. As an inter-staff communication history, a business communication system, a chat history, a meeting attendance record, a business handover record, a consultation/advice history between staff, minutes of a regular meeting, an exchange of gratitude/praise messages between staff, and the like are collected. As results of regular stress checks and health checkups, a stress level, a health risk score, guidance content from a doctor, an implementation status of health maintenance activities, a mental health consultation history, and the like are also acquired. As results of anonymous feedback from users and families and 360-degree evaluation, an opinion by free description, a score by 5-point evaluation or 10-point evaluation, an individual comment to specific staff, a letter or an email from a user's family, content of a letter of appreciation or a complaint, a feedback submission frequency, a chronological change of feedback, and the like are collected from a questionnaire system or a dedicated feedback system. For example, a free description in which a user writes “slow response at night”, “polite explanation”, “kind staff”, “polite meal assistance”, “felt uneasy during excretion assistance”, and the like, a satisfaction score by 5-point evaluation, a specific request from a family such as “grateful for staff's response” and “want a little more communication”, and the like are also acquired. Specifically, the data collection unit operates in a distributed computing environment. The data collection unit is executed on a server composed of a plurality of computing nodes. The data collection unit establishes a connection with an external system using an asynchronous communication protocol. The data collection unit receives an encrypted data packet via a secure communication path. The data collection unit temporarily stores the received packet in a buffer area on a memory. The data collection unit removes unnecessary noise from data using a parsing algorithm. The data collection unit inputs extracted text data to a natural language processing model. The natural language processing model adopts a multi-layer transformer architecture provided with a self-attention mechanism. Input data to the model is a two-dimensional tensor composed of word embedding vectors. The input data includes a plurality of 512-dimensional floating-point number vectors. As a specific example, first input data includes a numerical vector indicating an employment date. Second input data includes a vector obtained by converting a text of a care record. Third input data includes a vector obtained by converting a text of an incident report. Output data from the model is a high-dimensional vector from which a feature amount is extracted. The output data is a numerical array quantifying a semantic feature of each text. As a specific example, first output data includes a numerical value 0.85 indicating a positive emotion. Second output data includes a numerical value −0.42 indicating a negative emotion. Third output data includes a numerical value 0.12 indicating a neutral emotion. The data collection unit transfers the output feature amount vector to a subsequent database management unit. The data collection unit sorts and stores the feature amount vector in chronological order. With this configuration, the system automatically extracts a useful feature from unstructured data. The system eliminates a burden of manual data input by a human and dramatically improves a processing speed. The present technology is applicable as a data integration infrastructure in a large-scale nursing care provider operating a plurality of facilities.

The database management unit organizes these various data in chronological order, and manages the data so that the data can be searched, extracted, and aggregated from various perspectives such as for each manager, for each staff member, for each user, for each department, for each facility, and for each incident. For example, a data infrastructure for detailed analysis is constructed, such as a transition of a resignation rate of subordinate staff of a specific manager in the past three years, a year-by-year comparison of a transfer request rate of a certain facility, a chronological change of a care quality score of specific staff, a monthly transition of the number of incident occurrences, a chronological change of anonymous feedback, a correlation analysis between a training attendance history and a care quality score, a relationship between an inter-staff communication frequency and an incident occurrence rate, a correlation between user satisfaction and a care plan achievement rate, a relationship between a health risk score of staff and a resignation rate, and a relationship between a feedback frequency from a family and the number of complaints. For example, it is also possible to extract a period when a transfer request rate is high for each facility and collate it with a timing of organizational restructuring. Furthermore, a bias in care content and a specialty field can be extracted for each staff member, and can be utilized for appropriate personnel allocation and formulation of a training plan. Specifically, the database management unit executes a high-availability data store constructed on a distributed file system. The database management unit constructs an index structure specialized for time-series data. The database management unit utilizes a parallel computing processor for processing a multidimensional search query at high speed. The database management unit expands an input feature amount vector on a memory. The database management unit groups data using a clustering algorithm. The clustering model calculates a Euclidean distance between data in a high-dimensional space. Input data to the model is a multidimensional tensor including attribute information of staff and a care quality score. The input data is a 256-dimensional floating-point number vector. As a specific example, first input data includes a time-series array indicating a transition of a resignation rate. Second input data includes a numerical array indicating the number of incident occurrences. Third input data includes a numerical array indicating a sentiment score of anonymous feedback. Output data from the model is an integer value indicating an identifier of a cluster to which each data point belongs. The output data indicates a result of grouping based on data similarity. As a specific example, first output data includes an identifier 1 indicating a high-risk group. Second output data includes an identifier 2 indicating a low-risk group. Third output data includes an identifier 3 indicating an observation-required group. The database management unit assigns the output cluster identifier to each record as metadata. The database management unit optimizes a subsequent search process using the cluster identifier. With this configuration, the system instantly extracts a specific pattern from a vast amount of time-series data. The system enables discovery of a complex correlation that has been difficult with a conventional simple relational database. The present technology is applicable to an integrated personnel system for the purpose of employee performance analysis and risk management.

The generative AI analysis unit performs various AI analyses using the data accumulated in the database management unit. As the generative AI, a large language model, a gradient boosting model, a random forest, a neural network, a natural language processing model, a clustering model, an anomaly detection model, and the like are used in combination. First, a resignation rate and a transfer request rate of subordinate staff for each manager are calculated, and for example, the number of staff who resigned or the number of staff who submitted a transfer request in the past one year is aggregated and divided by the total number of subordinate staff to obtain a quantitative index. For example, when there are 10 staff members under a certain manager, and 2 of them resign and 1 submits a transfer request, the resignation rate is 20 percent and the transfer request rate is 10 percent. Regarding care quality, a care plan achievement rate, a user satisfaction questionnaire, a training attendance history, a qualification acquisition status, diversity of care content, a care implementation frequency, a care satisfaction score for each user, a record of gratitude/complaints from users, and the like are comprehensively evaluated, and a plurality of indices such as “an average care quality score of subordinate staff is 4.3 points”, “a care plan achievement rate is 95 percent”, “a user satisfaction average is 4.5 points”, and “a diversity score of care content is 0.8” are output. Regarding accidents/near-misses, the number of reports per staff member is calculated, and detailed indices such as “an incident occurrence rate is 0.2 cases/person-year”, “a severe incident occurrence rate is 0.05 cases/person-year”, and “an incident recurrence rate is 10 percent” are output. Specifically, the generative AI analysis unit executes an ensemble learning architecture integrating a plurality of deep learning models. The generative AI analysis unit operates a gradient boosting tree and a multilayer perceptron in parallel. The generative AI analysis unit reads a multidimensional tensor extracted from the database management unit into a memory. The generative AI analysis unit executes preprocessing of complementing a missing value with an average value. The generative AI analysis unit unifies a scale of data using a normalization algorithm. The neural network learns a complex feature using a non-linear activation function in a hidden layer. Input data to the model is a one-dimensional array including an action history and an evaluation index of staff. The input data is a 64-dimensional floating-point number vector. As a specific example, first input data includes a numerical value 2 indicating the number of resignees. Second input data includes a numerical value 0.95 indicating a care plan achievement rate. Third input data includes a numerical value 0.2 indicating an incident occurrence rate. Output data from the model is a floating-point number indicating a predicted value of a future resignation probability or care quality. The output data is a probability score normalized to a range from 0 to 1. As a specific example, first output data includes a numerical value 0.85 indicating a resignation probability. Second output data includes a numerical value 0.72 indicating a possibility of improving care quality. Third output data includes a numerical value 0.15 indicating an occurrence probability of a severe incident. The generative AI analysis unit compares the output predicted score with a predetermined threshold value. The generative AI analysis unit activates a subsequent alert generation module when the predicted score exceeds the threshold value. With this configuration, the system proactively predicts a future risk beyond simple aggregation based on past data. The system detects a minute sign unrecognizable to a human by calculation in a high-dimensional space, and improves prediction accuracy. The present technology is applicable to a measure for improving a human resource retention rate in a medical site or a nursing care facility.

Furthermore, regarding anonymous feedback from users and families, the generative AI analyzes a text using natural language processing, extracts keywords and emotions such as “reliable”, “kind”, “polite explanation”, “slow response”, “felt uneasy”, “dissatisfied with night response”, “staff's smile gives a sense of security”, “polite meal assistance”, and “lack of consideration during excretion assistance”, and creates a reliability score and an improvement point list for each manager. For example, when there are many negative comments, a specific improvement proposal such as “insufficient explanation by staff”, “uneasy about night response”, “little calling out during meal assistance”, and “insufficient consideration during excretion assistance” is automatically generated. Furthermore, a distribution of staff evaluation data and a tendency for each attribute are analyzed, a bias risk such as “consistently giving a low evaluation to female staff”, “giving a high evaluation to a specific qualification holder”, “strict evaluation for newly hired staff”, and “lenient evaluation for long-term employees” is detected, and a bias score is calculated. The AI also analyzes a relationship between a health risk score or a stress check result of staff and a resignation rate or an incident occurrence rate, and extracts a causal relationship such as “a resignation rate of staff with a high stress score is 1.5 times higher than an average” and “an incident occurrence rate of staff with a high health risk is doubled”. Specifically, the generative AI analysis unit executes a large language model specialized for natural language processing. The large language model adopts a transformer-based decoder architecture having billions of parameters. The generative AI analysis unit divides input text data into partial character strings using a tokenizer. The generative AI analysis unit converts each token into a high-dimensional embedding vector. Input data to the model is a three-dimensional tensor composed of token embedding vectors. The input data includes positional encoding for retaining context information. As a specific example, first input data includes a vector array obtained by converting a text “slow response”. Second input data includes a vector array obtained by converting a text “polite explanation”. Third input data includes a vector array obtained by converting a text “felt uneasy”. Output data from the model is a numerical vector indicating polarity and intensity of an emotion, and a list of extracted keywords. The output data is structured data quantifying an intention or an emotion behind a text. As a specific example, first output data includes a numerical value 0.9 indicating a negative degree and a keyword “night response”. Second output data includes a numerical value 0.8 indicating a positive degree and a keyword “meal assistance”. Third output data includes a numerical value 0.75 indicating a bias probability. The generative AI analysis unit recalculates a reliability score for each manager based on the output sentiment score. The generative AI analysis unit instructs a subsequent module to perform a correction process for ensuring fairness of evaluation when the bias probability exceeds a predetermined threshold value. With this configuration, the system automatically generates an objective evaluation index from an unstructured text. The system eliminates a blur in evaluation due to human subjectivity, and dramatically enhances transparency and fairness of an evaluation process. The present technology is applicable to a quality management system of any service industry that quantifies qualitative feedback from customers.

Based on these analysis results, the evaluation report generation unit automatically generates an evaluation report including specific numerical values and comments such as “a resignation rate of a manager X is 20 percent, a care quality score is 4.3 points, a care plan achievement rate is 95 percent, an incident occurrence rate is 0.2 cases/person-year, a severe incident occurrence rate is 0.05 cases/person-year, a reliability score is 0.75, improvement points: enhancement of night response is necessary, calling out during meal assistance should be increased, consideration during excretion assistance should be thorough, anonymous feedback: ‘polite explanation’, ‘uneasy about night response’, ‘polite meal assistance’, ‘uneasy during excretion assistance’”. The report is automatically updated monthly or quarterly, and can be viewed by the manager himself/herself, an upper-level manager, and an operation headquarters. Furthermore, when a resignation rate or an incident occurrence rate rapidly increases, or when a reliability score rapidly decreases, the alert notification unit transmits a warning to a related party in real time to prompt an early response. For example, a specific situation and a recommended action are notified, such as “a resignation rate of subordinate staff has exceeded 30 percent in the past three months. An urgent response is necessary”, “many opinions stating ‘uneasy about night response’ have been received in anonymous feedback. A review of a night system is recommended”, and “an incident occurrence rate has doubled compared to the previous month. Please re-evaluate a health condition and a workload of staff”. Specifically, the evaluation report generation unit dynamically synthesizes a human-readable text from structured data using a natural language generation algorithm. The evaluation report generation unit executes a template engine expanded on a memory. The evaluation report generation unit acquires various scores output from the generative AI analysis unit and extracted keywords. The evaluation report generation unit converts the acquired numerical values into a character string in accordance with a predetermined format. The evaluation report generation unit executes event-driven asynchronous processing in cooperation with the alert notification unit. Input data to the model is a multidimensional key-value data structure including an evaluation index for each manager. The input data is an array including a plurality of pairs of a numerical value and a character string. As a specific example, first input data includes a numerical value 0.2 indicating a resignation rate. Second input data includes a numerical value 4.3 indicating a care quality score. Third input data includes a character string array indicating an improvement point. Output data from the model is text data of a report described in a markup language. The output data includes visual decoration information and a structured text. As a specific example, first output data includes a red text block indicating a warning of a resignation rate. Second output data includes a data set for drawing a graph indicating a transition of care quality. Third output data includes a text block in which recommended actions are itemized. The evaluation report generation unit transfers the output report data to a subsequent distribution server. The alert notification unit immediately generates and transmits a packet for push notification when a specific index in the report exceeds a threshold value. With this configuration, the system converts a vast amount of analysis results into an instantly understandable format, and prevents a delay in decision-making. The system enables a rapid response to an abnormal situation of an organization by real-time data processing and a notification mechanism. The present technology is applicable to a management dashboard or a crisis management system requiring real-time performance.

The user interface unit on the terminal side allows each user such as a manager, staff, and a person in charge of an operation headquarters to access a server through a browser or a dedicated application, and perform viewing of an evaluation report, posting of feedback, implementation of a review session, confirmation of an improvement proposal, and the like. For example, a manager can check his/her own evaluation report, grasp a reliability score and an improvement point, and review a management behavior. Staff can post feedback anonymously, and check a past feedback history and his/her own career growth status. An operation headquarters and a person in charge of human resources can grasp an evaluation tendency and a bias risk of an entire facility or a plurality of facilities, and utilize them for system improvement and optimization of personnel allocation. For example, diverse interfaces are provided, such as a screen displaying a list of main indices in a dashboard format, a detailed display screen of an individual report, a feedback posting screen, and an agenda display screen for a review session. Specifically, the user interface unit executes a front-end program based on a single-page application architecture. The user interface unit constructs a virtual document object model operating on a web browser of a client terminal. The user interface unit communicates with an application programming interface on the server side using an asynchronous communication interface. The user interface unit stores the received report data in a state management store on a memory. The user interface unit detects a change in state and executes differential rendering of a screen at high speed. Input data to the rendering engine is a serialized state object acquired from the server. The input data is a data tree having a hierarchical structure. As a specific example, first input data is a node including profile information of a manager. Second input data is an array node including a history of a reliability score. Third input data is an array node including a list of improvement points. Output data from the rendering engine is a set of pixel information drawn on a screen. The output data indicates arrangement information of graphical elements visually recognizable by a user. As a specific example, first output data includes a drawing command of a pie chart indicating a score. Second output data includes arrangement coordinates of a text box for inputting feedback. Third output data includes a display instruction of a pop-up window indicating an alert. The user interface unit transmits the output drawing command to a graphics processing unit to update the screen. The user interface unit captures an input event from a user and triggers a subsequent data transmission process. With this configuration, the system provides smooth operability without making a user feel a network delay. The system significantly reduces a drawing load on the server by effectively utilizing computing resources on the client side. The present technology is applicable to any web-based business system involving complex data visualization.

The feedback input unit provides an interface allowing staff and users to anonymously post feedback to a manager and staff. For example, a plurality of questions and a free description column such as “about night response”, “about clarity of explanation”, “about kindness of staff”, “about calling out during meal assistance”, “about consideration during excretion assistance”, and “about cooperation between staff” are provided so that a frank opinion can be posted. The posted feedback is immediately transmitted to a server and analyzed by a generative AI analysis unit. For example, a device for enhancing psychological safety is applied, such as an input screen combining a multiple-choice question and a free description, a confirmation screen of a past posting history, and an automatic response message display after posting feedback. Specifically, the feedback input unit executes an input stream processing module operating on a client terminal. The feedback input unit captures a character code input from a keyboard or a touch panel by a user in real time. The feedback input unit executes a sanitization process on input text data to prevent mixing of a malicious code. The feedback input unit converts the input data into a secure packet using an encryption algorithm. The feedback input unit transmits the data to the server via an asynchronous messaging queue. Input data to the processing unit is an operation event of a user and input raw character string data. The input data is a one-dimensional array to which a time stamp and a session identifier are assigned. As a specific example, first input data includes an integer value 3 indicating a multiple-choice answer regarding night response. Second input data includes free description character string data regarding meal assistance. Third input data includes a boolean value indicating a click event of a transmission button. Output data from the processing unit is an encrypted payload serialized into a format transmittable to the server. The output data is a byte sequence transferred in a network layer. As a specific example, first output data is a packet including header information and encrypted answer data. Second output data is a packet including a status code indicating completion of input. Third output data is a control packet indicating a retransmission request at the time of a communication error. The feedback input unit transmits the output payload via a network interface. The feedback input unit clears an input form on a screen after completion of transmission, and executes a subsequent completion message display process. With this configuration, the system safely and reliably collects data while protecting user privacy. The system completes data transfer in a background without interrupting an input operation of a user by asynchronous transmission. The present technology is applicable to an internal reporting system or a questionnaire collection system requiring high anonymity and security.

The report viewing unit provides an interface through which the manager and a person in charge of the operation headquarters can view the evaluation report distributed from the server. For example, information is displayed in a visually easy-to-understand format, such as a transition graph of the resignation rate over the past year, a chronological change in the care quality score, a monthly transition of the number of incident occurrences, a heat map of the bias detection result, a transition graph of the reliability score, and details of the improvement point list. Various display formats such as a graph, a chart, a heat map, a text summary, and a comparison table are used. Specifically, the report viewing unit executes a data visualization library expanded on a memory of a client terminal. The report viewing unit restores compressed data received from the server using a decompression algorithm. The report viewing unit executes a coordinate transformation process for mapping the restored chronological data onto a two-dimensional canvas. The report viewing unit includes a mechanism for lazy-loading only necessary data in accordance with a user's scroll operation. Input data to the visualization engine is a multidimensional array indicating a chronological change of an evaluation index. The input data includes a plurality of pairs of a time stamp and a corresponding numerical value. As a specific example, first input data includes an array of floating-point numbers indicating the resignation rate for each month. Second input data includes an array of floating-point numbers indicating a transition of the care quality score. Third input data includes two-dimensional matrix data indicating the bias detection result. Output data from the visualization engine is a group of vector graphics instructions for drawing a graph or a heat map. The output data includes drawing parameters such as color information, line thickness, and vertex coordinates. As a specific example, first output data includes an instruction to draw an upward trend of the resignation rate with a red polygonal line. Second output data includes an instruction to draw a heat map that fills an area with a strong bias with a dark color. Third output data includes an instruction to generate a tooltip that displays detailed information when a cursor is placed on a specific data point. The report viewing unit passes the output drawing instruction to a rendering pipeline of a browser. The report viewing unit executes a subsequent process of dynamically recalculating a scale of the graph in accordance with a user's zoom operation. With this configuration, the system converts complex and multidimensional data into intuitively understandable visual information. The system reduces the number of times of communication with the server and improves a display speed by dynamic rendering on the client side. The present technology is applicable to a financial analysis tool or a marketing dashboard that handles a large amount of statistical data.

The review session support unit supports the manager and the subordinate staff to formulate a specific action plan while referring to the evaluation report, a feedback history, the improvement proposal by the AI, and the like when periodically conducting the review session. For example, the quality of the review session is improved by presenting an agenda and an action list automatically generated by the AI, such as “factor analysis of an increase in the resignation rate in the current term”, “background of a decrease in the reliability score”, “specific measure for improving the care quality”, “examination of a measure for preventing recurrence of an incident”, and “measure for strengthening inter-staff cooperation”. Functions such as a function of automatically listing agendas before the session, a function of displaying past improvement actions and their effects in chronological order, a function of recording a memo and an action plan in real time during the session, and a function of automatically notifying a follow-up task after the session are provided. Specifically, the review session support unit shares a session state among a plurality of terminals using a real-time state synchronization protocol. The review session support unit reads agenda data constructed by the generative AI into a state transition machine on a memory. The review session support unit dynamically switches display contents of a screen in accordance with a progress status of the session. The review session support unit records the memo and the action plan input by the user as a chronological event log using an event sourcing pattern. Input data to the recommendation algorithm is a feature vector of a past session history and a current evaluation report. The input data is a 128-dimensional floating-point number vector. As a specific example, first input data includes an embedding vector of text indicating a factor of an increase in the resignation rate. Second input data includes an identifier of an improvement measure that has succeeded in the past. Third input data includes a numerical value indicating a decrease width of the current care quality score. Output data from the recommendation algorithm is structured data indicating a list of recommended agendas and action plans. The output data is an array including a priority score of each proposal. As a specific example, first output data includes a priority score of 0.9 and an agenda of reviewing a nighttime system. Second output data includes a priority score of 0.8 and an agenda of activating inter-staff communication. Third output data includes a priority score of 0.7 and an agenda of reconstructing a training program. The review session support unit sorts the output list in descending order of priority and displays the list on the screen. The review session support unit registers the selected action plan in a subsequent task management database. With this configuration, the system structures the progress of a meeting, prevents a deviation of a discussion, and forces formulation of an effective action. The system complements a lack of experience of the manager by a data-driven proposal based on a past success case. The present technology is applicable to a project management tool or an online meeting support system.

Furthermore, for example, when the manager implements an improvement action, it is also possible to report the content from the terminal to the server, and for the AI to monitor a subsequent change in the resignation rate or the reliability score and quantitatively evaluate an improvement effect. For example, effect verification of an improvement measure can also be automated, such as “as a result of strengthening the nighttime response system, the reliability score increased from 0.6 to 0.8”, “as a result of increasing calling out during meal assistance, the user satisfaction improved from 4.2 to 4.6”, and “as a result of introducing a measure for strengthening inter-staff cooperation, the incident occurrence rate decreased from 0.2 occurrences/person-year to 0.1 occurrences/person-year”. Specifically, the system executes an effect measurement module combining a time-series prediction model and a causal inference algorithm. The module acquires an implementation record of the improvement action input by the manager from the database. The module automatically executes a statistical hypothesis test for comparing a transition of an evaluation index before and after the implementation of the action. The module generates a control group using propensity score matching in order to eliminate an influence of an external factor. Input data to the causal inference model is a binary variable indicating whether or not the action has been implemented, and a chronological array of the evaluation index in a target period. The input data is expressed in a multidimensional tensor format. As a specific example, first input data includes a flag value of 1 indicating that the nighttime response system has been strengthened. Second input data includes an array of the reliability score for one month before the implementation. Third input data includes an array of the reliability score for one month after the implementation. Output data from the causal inference model is an estimated value indicating a pure causal effect given to the index by the improvement action, and a confidence interval thereof. The output data includes a P-value indicating statistical significance. As a specific example, first output data includes a numerical value of +0.2 indicating an improvement effect of the reliability score. Second output data includes a numerical value of −0.1 indicating a reduction effect of the incident occurrence rate. Third output data includes a P-value of 0.01 indicating the significance of the effect. The module feeds back the output estimated value of the causal effect to the evaluation report generation unit. The module adds the action whose effect has been confirmed to learning data of a subsequent recommendation algorithm as a success case. With this configuration, the system quantitatively proves a true effect of the measure, not a mere correlation. The system continuously re-learns the AI model through a feedback loop, and self-evolves the accuracy of the proposal. The present technology is applicable to an A/B test of a marketing measure or a policy evaluation system.

As described above, the embodiment of the present invention realizes a system that centrally executes data collection, multifaceted analysis by the generative AI, evaluation report generation, alert notification, and database management on the server side, and is configured such that the user performs report viewing, feedback posting, a review session, implementation/reporting of an improvement action, and the like on the terminal side, thereby realizing manager evaluation in a nursing care site fairly and transparently, and strongly supporting staff retention, care quality improvement, user satisfaction improvement, and sound organizational operation. The generative AI plays a core role in the system, such as integrated analysis of data, bias detection, feedback analysis by natural language processing, prediction of a care quality improvement possibility, automatic generation of an improvement proposal, and effect verification of an improvement measure, thereby breaking away from conventional personalized and subjective evaluation, and enabling realization of a manager evaluation system having both objectivity and transparency. Specifically, the system adopts a microservice architecture, and executes each functional module as an independent container on an orchestration platform. The system distributes requests from clients to a plurality of computing nodes via a load balancer. The system integrates a series of processes from data collection to AI analysis and report generation as an automated data pipeline. The system utilizes an in-memory database to maximize a read/write speed of intermediate data. Input data to the integrated control unit is status information and log data of a processing result asynchronously transmitted from each microservice. The input data is a chronological metrics array indicating an operation status of the entire system. As a specific example, first input data includes an event notification indicating completion of processing of the data collection unit. Second input data includes a numerical value indicating an inference latency of the AI analysis unit. Third input data includes a numerical value indicating a memory usage amount of the report generation unit. Output data from the integrated control unit is a control command instructing dynamic allocation of system resources. The output data is a group of instructions for executing scale-out or scale-in of a container. As a specific example, first output data includes a command to additionally start a computing instance for AI analysis. Second output data includes a command to release an unnecessary cache memory. Third output data includes a command instructing traffic switching from a failed node. The integrated control unit transmits the output command to an infrastructure management interface to dynamically change a system configuration. The integrated control unit executes a subsequent process of autonomously resolving a processing bottleneck. With this configuration, the system maintains high throughput and fault tolerance even against sudden access concentration or large-scale data input. The system maximizes utilization efficiency of computer resources, reduces an operation cost, and stably provides an objective and transparent evaluation infrastructure. The present technology is applicable to mission-critical enterprise cloud services in general.

### (System Configuration)

The system according to the present embodiment includes a data collection unit, a database management unit, a generative AI analysis unit, an evaluation report generation unit, an alert notification unit, a user interface unit, a feedback input unit, a report viewing unit, and a review session support unit. The data collection unit is a unit configured to automatically and periodically collect data regarding the manager and the subordinate staff from diverse information sources inside and outside a nursing care facility, and acquires, for example, an employment date, a resignation date, a transfer request, a reassignment history, a training attendance history, a qualification acquisition status, years of service, a past evaluation score, a promotion history, a reward and punishment history, and the like from a personnel management system of nursing care staff, acquires a care plan achievement rate, a daily care record, care content for each user, a care implementation frequency, details of care content (meal assistance, bathing assistance, excretion assistance, rehabilitation support, recreation implementation status, and the like), a user satisfaction questionnaire result, a care satisfaction score for each user, a record of direct gratitude or complaint from a user, and the like from a care record system, acquires the number of incident occurrences, an occurrence date and time, an occurrence location, an occurrence cause, response content, a recurrence prevention measure, involved staff, a severity classification of an incident, a follow-up status after an incident occurrence, and the like from an accident/near-miss report system, collects a business communication system, a chat history, a meeting attendance record, a business handover record, a consultation/advice history between staff, minutes of a regular meeting, an exchange of gratitude/praise messages between staff, and the like as an inter-staff communication history, also acquires a stress degree, a health risk score, guidance content from a doctor, an implementation status of a health maintenance activity, a mental health consultation history, and the like as a result of a regular stress check or health checkup, and collects a free-description opinion, a score by a 5-point evaluation or a 10-point evaluation, an individual comment to specific staff, a letter or an email from a user's family, content of a letter of appreciation or a complaint, a feedback submission frequency, a chronological change of feedback, and the like from a questionnaire system or a dedicated feedback system as a result of anonymous feedback or a 360-degree evaluation from users and families. Specifically, the data collection unit is executed by generating a parallel processing thread on a computing server including a multi-core processor. The data collection unit constructs a data pipeline responsible for extraction, transformation, and loading. The data collection unit normalizes heterogeneous data acquired from diverse external information sources into a unified internal format. The data collection unit applies a data cleansing algorithm that performs complementation of a missing value and removal of an abnormal value. Input data to the preprocessing module is a plurality of raw data records having different schemas. The input data is a one-dimensional array in which diverse data types such as a character string, an integer, a floating-point number, and a date type are mixed. As a specific example, first input data includes a date character string indicating an employment date acquired from the personnel management system. Second input data includes free-description text data acquired from the care record system. Third input data includes numerical data indicating a health checkup result. Output data from the preprocessing module is a multidimensional numerical tensor converted into a format processable by a machine learning model. The output data includes data obtained by converting a categorical variable into a binary array. As a specific example, first output data includes a floating-point number 0.5 obtained by normalizing years of service. Second output data includes a 512-dimensional array obtained by vectorizing text. Third output data includes an integer value 2 indicating a health risk in three stages. The data collection unit transfers the output numerical tensor to the subsequent database management unit via a high-speed messaging queue. The data collection unit asynchronously writes a completion state of processing to a log file. With this configuration, the system integrates a huge amount of data having different formats in real time, and ensures the accuracy of subsequent AI analysis. The system significantly reduces a calculation cost and time required for data preparation. The present technology is applicable to a digital transformation infrastructure that integrates a plurality of legacy systems.

The database management unit is a unit configured to organize the various data acquired by the data collection unit in chronological order, and manage the data so that the data can be searched, extracted, and aggregated from various perspectives such as for each manager, for each staff member, for each user, for each department, for each facility, and for each incident. For example, a data infrastructure for detailed analysis is constructed, such as a transition of a resignation rate of subordinate staff of a specific manager in the past three years, a year-by-year comparison of a transfer request rate of a certain facility, a chronological change in a care quality score of specific staff, a monthly transition of the number of incident occurrences, a chronological change in anonymous feedback, a correlation analysis between a training attendance history and a care quality score, a relationship between an inter-staff communication frequency and an incident occurrence rate, a correlation between user satisfaction and a care plan achievement rate, a relationship between a health risk score of staff and a resignation rate, and a relationship between a feedback frequency from a family and the number of complaints. For example, it is also possible to extract a period when the transfer request rate is high for each facility and collate it with a timing of organizational restructuring, and it is also possible to extract a bias in care content or a field of expertise for each staff member and utilize it for appropriate personnel allocation or formulation of a training plan. Specifically, the database management unit adopts a hybrid configuration combining a relational database and a non-relational database. The database management unit executes a routing engine that dynamically distributes a storage destination in accordance with characteristics of data. The database management unit applies a sharding technology that distributes and arranges data in a plurality of physical servers in order to realize high-speed reading and writing of large-scale data. The database management unit optimizes an execution plan of a search request using a query optimizer. Input data to the search engine is a multidimensional search query issued from a user or the inside of the system. The input data is a structured parameter group specifying a search condition, a sort order, the number of acquisitions, and the like. As a specific example, first input data includes a period designation parameter of the past three years of a specific facility. Second input data includes a threshold condition that the resignation rate is equal to or greater than a certain value. Third input data includes a sort condition of descending order of the care quality score. Output data from the search engine is a set of records matching the condition and a statistical value calculated by an aggregation function. The output data is a pointer array of a result set expanded on a memory. As a specific example, first output data includes an identifier list of staff satisfying the condition. Second output data includes a numerical value indicating an average value of the number of incident occurrences by month. Third output data includes metadata indicating an execution time required for a search process. The database management unit returns the output result set to a requesting module. The database management unit executes a subsequent process of storing a result of a frequently executed query in an in-memory cache. With this configuration, the system guarantees a response speed in milliseconds even for petabyte-class data. The system suppresses consumption of a network bandwidth by completing a complex aggregation process on the database side. The present technology is applicable to a large-scale log analysis system or a real-time monitoring system.

The generative AI analysis unit is a unit configured to perform various AI analyses using the data accumulated in the database management unit, and uses a large language model, a gradient boosting model, a random forest, a neural network, a natural language processing model, a clustering model, an anomaly detection model, and the like in combination. The generative AI analysis unit calculates a resignation rate and a transfer request rate of the subordinate staff for each manager, aggregates, for example, the number of staff who resigned or the number of staff who submitted a transfer request in the past year, and divides the number by the total number of subordinate staff to obtain a quantitative index, comprehensively evaluates care quality based on a care plan achievement rate, a user satisfaction questionnaire, a training attendance history, a qualification acquisition status, diversity of care content, a care implementation frequency, a care satisfaction score for each user, a record of gratitude/complaint from a user, and the like, outputs a plurality of indices such as “an average care quality score of subordinate staff is 4.3 points”, “a care plan achievement rate is 95 percent”, “a user satisfaction average is 4.5 points”, and “a diversity score of care content is 0.8”, calculates the number of reports per staff member for accidents/near-misses, and outputs detailed indices such as “an incident occurrence rate is 0.2 occurrences/person-year”, “a major incident occurrence rate is 0.05 occurrences/person-year”, and “an incident recurrence rate is 10 percent”. Furthermore, regarding anonymous feedback from users and families, the generative AI analyzes text using natural language processing, extracts keywords and emotions such as “reliable”, “kind”, “polite explanation”, “slow response”, “felt uneasy”, “dissatisfied with nighttime response”, “staff's smile gives a sense of security”, “polite meal assistance”, and “lack of consideration during excretion assistance”, creates a reliability score and an improvement point list for each manager, automatically generates a specific improvement proposal such as “insufficient explanation by staff”, “uneasy about nighttime response”, “little calling out during meal assistance”, and “lack of consideration during excretion assistance” when there are many negative comments, analyzes a distribution of staff evaluation data and a tendency for each attribute, detects a bias risk such as “consistently giving a low evaluation to female staff”, “giving a high evaluation to a specific qualification holder”, “strict evaluation for newly hired staff”, and “lenient evaluation for long-term employees”, calculates a bias score, also analyzes a relationship between a health risk score or a stress check result of staff and a resignation rate or an incident occurrence rate, and extracts a causal relationship such as “a resignation rate of staff with a high stress score is 1.5 times higher than an average” and “an incident occurrence rate of staff with a high health risk is twice”. Specific examples of a prompt sentence to be read by the generative AI include “calculate a resignation rate, a transfer request rate, a care quality score, and an incident occurrence rate of subordinate staff of manager X in the past year, perform emotion analysis of anonymous feedback, and extract a reliability score and an improvement point”, “predict a care quality improvement possibility within the next half year based on a care record, a training attendance history, and a satisfaction questionnaire result of staff Y”, “analyze staff evaluation data of manager Z for each attribute, detect presence or absence of an evaluation bias, and calculate a bias score”, and “analyze text data of anonymous feedback by natural language processing, summarize a negative opinion, and generate an improvement proposal”. Specifically, the generative AI analysis unit controls an inference process of a large language model using a prompt engineering technology. The generative AI analysis unit loads a dedicated model subjected to fine-tuning for specializing in a specific task onto a memory. The generative AI analysis unit includes a learning phase of calculating a difference between an output of the model and correct answer data using a cross-entropy error function, and updating a weight parameter by a gradient descent method. The generative AI analysis unit calculates a probability distribution for input data at high speed in an inference phase. Input data to the model is an integer array obtained by tokenizing a prompt character string automatically generated by the system. The input data includes context information and specific instruction content. As a specific example, first input data includes a token sequence indicating an instruction to calculate the resignation rate of manager X. Second input data includes a token sequence indicating an instruction to predict a care quality improvement possibility. Third input data includes a token sequence indicating an instruction to detect presence or absence of an evaluation bias. Output data from the model is a token sequence of generated text and a numerical array indicating a generation probability of each token. The output data includes an answer in natural language and a score indicating a certainty factor of the answer. As a specific example, first output data includes a token sequence of text that the resignation rate is 20 percent. Second output data includes a token sequence of text that the bias score is 0.8. Third output data includes a numerical value 0.95 indicating a generation probability. The generative AI analysis unit inversely converts the output token sequence into a human-readable character string using a decoder. The generative AI analysis unit executes a subsequent process of discarding an inference result and requesting recalculation when the certainty factor score falls below a predetermined threshold. With this configuration, the system flexibly executes a complex analysis task only by an instruction in natural language. The system understands a context and derives an appropriate result even for an ambiguous input that cannot be handled by a rule-based program. The present technology is applicable to an automatic response system or a decision-making support system that requires a high inference capability.

The evaluation report generation unit is a unit configured to automatically generate an evaluation report for each manager including the resignation rate, the transfer request rate, the care quality score, the care plan achievement rate, the incident occurrence rate, a major incident occurrence rate, the reliability score, the improvement point list, the bias detection result, and the like obtained by the generative AI analysis unit, and the report is automatically updated monthly or quarterly and can be viewed by the manager himself/herself, an upper-level manager, and the operation headquarters. For example, an evaluation report including specific numerical values and comments is automatically generated, such as “manager X's resignation rate is 20 percent, care quality score is 4.3 points, care plan achievement rate is 95 percent, incident occurrence rate is 0.2 occurrences/person-year, major incident occurrence rate is 0.05 occurrences/person-year, reliability score is 0.75, improvement point: strengthening of nighttime response is necessary, calling out during meal assistance should be increased, consideration during excretion assistance should be thorough, anonymous feedback: ‘polite explanation’, ‘uneasy about nighttime response’, ‘polite meal assistance’, ‘uneasy during excretion assistance’”, and furthermore, when the resignation rate or the incident occurrence rate rapidly increases, or when the reliability score rapidly decreases, the alert notification unit transmits a warning to a related person in real time to prompt an early response. For example, a specific situation and a recommended action are notified, such as “the resignation rate of subordinate staff has exceeded 30 percent in the past three months. An urgent response is necessary”, “many opinions stating ‘uneasy about nighttime response’ have been received in anonymous feedback. A review of the nighttime system is recommended”, and “the incident occurrence rate has doubled compared to the previous month. Please re-evaluate the health condition and workload of staff”. Specifically, the evaluation report generation unit is executed as a background process periodically started by a batch processing scheduler. The evaluation report generation unit expands a generation engine of a markup language or a document format on a memory. The evaluation report generation unit maps structured data received from the generative AI analysis unit to a predefined layout template. The evaluation report generation unit constructs a tree structure of a document object model on a memory. Input data to the generation engine is multidimensional dictionary-type data including an evaluation index, an improvement point list, and a bias detection result for each manager. The input data is a set of key-value pairs. As a specific example, first input data includes a pair of a key resignation rate and a value 20 percent. Second input data includes a pair of a key reliability score and a value 0.75. Third input data includes an array of a key improvement point and a value. Output data from the generation engine is a binary file or a text file serialized into a renderable format. The output data includes font information, layout coordinates, and embedded image data. As a specific example, first output data includes a byte sequence of a document file in which a graph image is embedded. Second output data includes a text character string displayable on a web browser. Third output data includes metadata indicating a generation date and time and a file size. The evaluation report generation unit stores the output file in a secure storage area. The evaluation report generation unit executes a subsequent process of recording a storage path of the file in a database and transmitting a completion signal to the alert notification unit. With this configuration, the system collectively generates individualized reports for managers on a scale of thousands of people in a short time. The system completely eliminates man-hours for manual report creation and maintains freshness of information. The present technology is applicable to a monthly reporting system of a financial institution or the like that requires a large amount of form output.

The user interface unit is a unit for each user such as the manager, the staff, and the person in charge of the operation headquarters to access the server through a browser or a dedicated application, and perform viewing of the evaluation report, posting of feedback, implementation of a review session, confirmation of an improvement proposal, and the like, and for example, the manager can confirm his/her own evaluation report, grasp the reliability score and the improvement point, and review a management behavior, the staff can anonymously post feedback and confirm a past feedback history and his/her own career growth status, and the operation headquarters and a person in charge of human resources can grasp an evaluation tendency and a bias risk of the entire facility or a plurality of facilities, and utilize them for system improvement and optimization of personnel allocation. Various interfaces are provided, such as a screen for displaying a list of main indices in a dashboard format, a detailed display screen of an individual report, a feedback posting screen, and an agenda display screen for a review session. Specifically, the user interface unit manages a virtual document object model of a front-end framework operating on a client terminal. The user interface unit asynchronously captures an operation event of a user and updates data in a state management store. The user interface unit communicates with a back-end server via a communication interface gateway. The user interface unit implements a role-based access control mechanism, and dynamically generates a screen display in accordance with an authority of a user. Input data to the access control module is an authentication token of a user and an identifier of a requested resource. The input data includes an encrypted character string and path information. As a specific example, first input data includes an authentication token indicating a manager authority. Second input data includes a path character string requesting viewing of a report of a specific facility. Third input data includes a session identifier of a user. Output data from the access control module is a boolean value of access permission and a filtering rule of data permitted to be displayed to a user. The output data is a parameter group for controlling a subsequent data acquisition process. As a specific example, first output data includes a boolean value true indicating access permission. Second output data includes a conditional expression for extracting only data of an own department. Third output data includes a flag instructing non-display of an edit button. The user interface unit transmits a data acquisition request to the server by adding the output filtering rule. The user interface unit executes a subsequent process of binding received data to a component on a screen and redrawing the component. With this configuration, the system provides safe and appropriate information to diverse user layers with a single application. The system strongly prevents unauthorized access to unauthorized data on both the client side and the server side. The present technology is applicable to an internal portal system of a company having a complex organizational hierarchy.

The feedback input unit is a unit that provides an interface allowing staff and users to anonymously post feedback on managers and staff, provides a plurality of questions and free description fields such as “about nighttime response”, “about clarity of explanation”, “about kindness of staff”, “about calling out during meal assistance”, “about consideration during excretion assistance”, and “about cooperation among staff” so that frank opinions can be posted, and the posted feedback is immediately transmitted to the server and analyzed by the generative AI analysis unit. Devices for enhancing psychological safety are applied, such as an input screen combining multiple-choice questions and free descriptions, a confirmation screen for past posting history, and an automatic response message display after posting feedback. Specifically, the feedback input unit makes an event listener that monitors a state of an input form resident on a memory of a client terminal. The feedback input unit executes a validation process of an input value using a regular expression in real time every time a user inputs a character. The feedback input unit applies an escape process to prevent a malicious script attack. The feedback input unit temporarily stores data being input in a local storage of a browser to prepare for an unexpected communication disconnection. Input data to the validation module is an identifier of an input field and raw character string data input by the user. The input data is an array of character codes extracted from a keyboard event. As a specific example, first input data includes an identifier of a question regarding the nighttime response. Second input data includes a text character string input by the user. Third input data includes an integer value indicating a selection state of a multiple-choice radio button. Output data from the validation module is a boolean value indicating validity of the input value and a warning message character string when an error exists. The output data is a control signal for updating a display state of the screen. As a specific example, first output data includes a boolean value true indicating validity. Second output data includes an error message indicating that a character count limit is exceeded. Third output data includes a warning flag of an unentered required item. The feedback input unit enables a transmission button only when the output boolean value is true. The feedback input unit executes a subsequent process of serializing the input data into a structured format and asynchronously transmitting the serialized input data to the server when the transmission button is pressed. With this configuration, the system prevents incomplete or invalid data from reaching the server. The system returns feedback to the user immediately, thereby reducing input errors and improving the quality of data collection. The present technology is applicable to an online application system requiring high data consistency.

The report viewing unit is a unit that provides an interface allowing a manager and a person in charge of an operation headquarters to view an evaluation report distributed from the server, and displays information in a visually easy-to-understand format, such as a transition graph of a resignation rate over the past year, a chronological change in a care quality score, a monthly transition of incident occurrences, a heat map of a bias detection result, a transition graph of a reliability score, and details of an improvement point list. Various display formats such as graphs, charts, heat maps, text summaries, and comparison tables are used. Specifically, the report viewing unit enables hardware acceleration by a graphics processing unit of the client terminal using a web graphics library. The report viewing unit executes a shader program for drawing a graph having a large amount of data points at high speed. The report viewing unit implements a culling process of skipping drawing of an element outside the screen. The report viewing unit deploys a cross-filtering engine that dynamically filters data in accordance with a user interaction on a memory. Input data to the filtering engine is a filter condition selected by the user on the screen and an entire data set cached on the memory. The input data is a combination of a multidimensional array and a conditional expression. As a specific example, first input data includes a period filter condition specifying a specific month. Second input data includes a category filter condition specifying a specific incident type. Third input data includes a multidimensional array including evaluation scores of all staff. Output data from the filtering engine is a subset array obtained by extracting only data points matching the condition. The output data is a lightweight data structure optimized for redrawing. As a specific example, first output data includes an array including only data of the specified month. Second output data includes a set of vectors indicating occurrence coordinates of the specific incident. Third output data includes a recalculated numerical value indicating an average score after filtering. The report viewing unit passes the output subset array to a drawing pipeline, and synchronously updates all graphs on the screen. The report viewing unit executes a subsequent process of storing a filtering state as a query parameter of a URL and enabling sharing of the state. With this configuration, the system enables a complex dashboard including tens of thousands of data points to be operated without delay. The system supports a process in which the user explores data from multiple angles, and promotes acquisition of deep insight. The present technology is applicable to a business intelligence tool handling big data.

The review session support unit is a unit that supports a manager and subordinate staff to formulate a specific action plan while referring to an evaluation report, a feedback history, an improvement proposal by AI, and the like when periodically conducting a review session, and improves the quality of the review session by presenting an agenda and an action list automatically generated by the AI, such as “factor analysis of resignation rate increase in this term”, “background of reliability score decrease”, “specific measure for care quality improvement”, “examination of incident recurrence prevention measure”, and “measure for strengthening cooperation among staff”. The review session support unit includes a function of automatically listing agendas before the session, a function of displaying past improvement actions and their effects in chronological order, a function of recording memos and action plans in real time during the session, a function of automatically notifying a follow-up task after the session, and the like. Specifically, the review session support unit executes a state machine that manages a progress state of the session on the server. The review session support unit synchronizes a screen state and input content between terminals of participants in milliseconds using a bidirectional communication protocol. The review session support unit automatically constructs an optimal agenda from past data and a current issue using a natural language generation model. The review session support unit executes a text analysis process of extracting a decided matter after the session ends. Input data to the text analysis module is text data of minutes recorded during the session and an input log of the action plan. The input data is a character string array with a time stamp. As a specific example, first input data includes metadata indicating who spoke and when. Second input data includes text of the decided specific measure. Third input data includes a character string indicating a person in charge and a deadline. Output data from the text analysis module is structured data of an extracted task. The output data is an object in a format registrable in a task management system. As a specific example, first output data includes a task name review of nighttime system. Second output data includes a pair of an identifier of the person in charge and a deadline date and time. Third output data includes an integer value indicating a priority of the task. The review session support unit inserts the output task data into a database. The review session support unit executes a subsequent process of transmitting a push message notifying the terminal of the person in charge of assignment of the task. With this configuration, the system completely automates conversion from a meeting record to an executable task. The system prevents omission of decided matters and dramatically enhances execution capability of an organization. The present technology is applicable to a retrospective support tool in agile development, and the like.

As described above, the system according to the present embodiment realizes data collection, data management, AI analysis, report generation, alert notification, user interface, feedback input, report viewing, and review session support by cooperation of the respective units, enhances fairness, transparency, and objectivity of manager evaluation in a nursing care site with the generative AI as a core, and realizes retention of staff, improvement of care quality, improvement of user satisfaction, and sound organizational operation. Specifically, the system adopts an event-driven architecture in which the above-described units loosely couple and cooperate via an asynchronous messaging queue. The system positions the generative AI as an inference engine serving as the core of the system, and constructs a pipeline in which all data flows pass through an AI model. The system models a series of cycles from data input to analysis, report generation, and feedback collection as a closed-loop control system. The system periodically updates a weight parameter of the AI model through a pipeline of continuous integration and continuous deployment. Input data to the inference engine is multidimensional operation metrics and a user behavior log collected from the entire system. The input data is a large-scale time-series tensor extending to millions of rows. As a specific example, first input data includes a numerical array indicating the number of calls of each functional module. Second input data includes a numerical array indicating a screen stay time of the user. Third input data includes a numerical array indicating a transition of an error rate of a prediction model. Output data from the inference engine is an adjustment value of a parameter for optimization of the entire system and a future performance prediction value. The output data is a control vector passed to a self-tuning algorithm. As a specific example, first output data includes an adjustment value for extending an expiration date of a cache. Second output data includes a flag instructing relearning of a specific AI model. Third output data includes a numerical value indicating a system load prediction for the next week. The system autonomously optimizes a system configuration using the output control vector. The system executes a subsequent process of provisioning a server resource in advance in accordance with the predicted load. With this configuration, the system realizes a self-evolving platform in which accuracy of evaluation and processing efficiency of the system improve as operation continues. The system ensures extremely high objectivity and transparency while minimizing human intervention. The present technology is applicable to a next-generation social infrastructure system that models dynamics of a complex human society and proposes an optimal intervention.

### (Implementation Steps)

Step 1: Comprehensive Collection of Nursing Care Site Data In this step, the data collection unit automatically and periodically collects data regarding a manager and subordinate staff from diverse information sources inside and outside a nursing care facility. For example, an employment date, a resignation date, a transfer request, a reassignment history, a training attendance history, a qualification acquisition status, years of continuous service, a past evaluation score, a promotion history, a reward and punishment history, and the like are acquired from a personnel management system of nursing care staff, and a care plan achievement rate, a daily care record, care content for each user, a care implementation frequency, details of care content (meal assistance, bathing assistance, excretion assistance, rehabilitation support, recreation implementation status, and the like), a user satisfaction questionnaire result, a care satisfaction score for each user, a record of direct gratitude and complaints from users, and the like are acquired from a care record system. The number of incident occurrences, an occurrence date and time, an occurrence location, an occurrence cause, response content, a recurrence prevention measure, involved staff, a severity classification of an incident, a follow-up status after an incident occurrence, and the like are acquired from an accident/near-miss report system, and a business communication system, a chat history, a meeting attendance record, a business handover record, a consultation/advice history among staff, minutes of a regular meeting, an exchange of gratitude/praise messages among staff, and the like are collected as a communication history among staff. A stress degree, a health risk score, guidance content from a doctor, an implementation status of a health maintenance activity, a mental health consultation history, and the like are also acquired as results of a regular stress check and health checkup, and an opinion by free description, a score by a 5-point evaluation or a 10-point evaluation, an individual comment to specific staff, a letter or an email from a user's family, content of a letter of appreciation or a complaint, a feedback submission frequency, a chronological change in feedback, and the like are collected from a questionnaire system or a dedicated feedback system as results of anonymous feedback from users and families and a 360-degree evaluation. Specifically, the data collection unit operates in a distributed computing environment. The data collection unit establishes a connection to a plurality of external systems using an asynchronous communication protocol. The data collection unit acquires data via an application programming interface provided from each system. The data collection unit buffers the acquired data in a temporary memory area. The data collection unit executes a data cleansing process on the buffered data. The data collection unit complements or removes a missing value or an abnormal value using a statistical method. The data collection unit converts the cleansed data into a unified data schema. The data collection unit transfers the converted data to a time-series database. The data collection unit applies a data compression algorithm during data transfer. The data collection unit minimizes consumption of a network bandwidth. The data collection unit executes a periodic batch process and a real-time streaming process in parallel. The data collection unit always maintains freshness of data in the latest state. The data collection unit protects confidentiality of data using an encrypted communication protocol. The data collection unit verifies an acquisition authority of data by referring to an access control list. The data collection unit blocks an unauthorized access. The data collection unit monitors a processing load of the entire system. The data collection unit dynamically adjusts a frequency of data acquisition in accordance with a load status. The data collection unit realizes automation of data collection by these processes. The data collection unit completely eliminates a manual data input operation by a human. The data collection unit prevents a human error during data input. The data collection unit significantly reduces time required for data collection. The data collection unit improves processing efficiency of the entire computer system. The data collection unit enables real-time monitoring in a large-scale nursing care facility network. The data collection unit provides a foundation for centrally managing information from diverse data sources.
Step 2: Chronological Storage in Database and Multi-axis Management In this step, the database management unit organizes the various data collected in the previous step in chronological order, and manages the data so that the data can be searched, extracted, and aggregated from various perspectives such as for each manager, for each staff member, for each user, for each department, for each facility, and for each incident. For example, a data infrastructure for detailed analysis is constructed, such as a transition of a resignation rate of subordinate staff of a specific manager in the past three years, a year-by-year comparison of a transfer request rate of a certain facility, a chronological change in a care quality score of specific staff, a monthly transition of incident occurrences, a chronological change in anonymous feedback, a correlation analysis between a training attendance history and a care quality score, a relationship between an inter-staff communication frequency and an incident occurrence rate, a correlation between user satisfaction and a care plan achievement rate, a relationship between a health risk score of staff and a resignation rate, and a relationship between a feedback frequency from a family and the number of complaints. Specifically, the database management unit executes a highly available data store constructed on a distributed file system. The database management unit stores the collected data using an index structure specialized for time-series data. The database management unit constructs a multidimensional index for processing a multidimensional search query at high speed. The database management unit expresses data as nodes and edges of a graph database. The database management unit defines a manager, staff, a user, and an incident as the nodes. The database management unit defines a relationship and an interaction among them as the edges. The database management unit executes a graph search algorithm. The database management unit extracts a complex correlation at high speed in a high-dimensional space. The database management unit uses an in-memory database together. The database management unit caches frequently accessed data on a memory. The database management unit reduces input/output operations to a disk. The database management unit reduces latency of data search to the utmost limit. The database management unit executes a data redundancy process. The database management unit prevents data loss during a hardware failure. The database management unit executes data partitioning. The database management unit distributes and arranges large-scale data in a plurality of storage nodes. The database management unit enables an aggregation operation by parallel processing. The database management unit dramatically improves a search speed by these processes. The database management unit executes an unconventional procedure fundamentally different from a conventional aggregation operation using spreadsheet software by a human. The database management unit discovers a hidden data correlation by an operation in a high-dimensional space. The database management unit enables integrated analysis of personnel data and care quality data across a plurality of facilities. The database management unit provides a data infrastructure that immediately responds to an ad-hoc data analysis request for the management layer.
Step 3: Multifaceted Evaluation and Analysis by Generative AI In this step, the generative AI analysis unit performs various AI analyses using the data accumulated in the database management unit. A resignation rate and a transfer request rate of subordinate staff for each manager are calculated, and for example, the number of staff who resigned and the number of staff who submitted a transfer request in the past year are aggregated and divided by the total number of subordinate staff to obtain a quantitative index. Regarding care quality, a care plan achievement rate, a user satisfaction questionnaire, a training attendance history, a qualification acquisition status, diversity of care content, a care implementation frequency, a care satisfaction score for each user, a record of gratitude and complaints from users, and the like are comprehensively evaluated, and regarding accidents and near-misses, the number of reports per staff member, a serious incident occurrence rate, a recurrence rate, and the like are calculated. Furthermore, regarding anonymous feedback from users and families, the generative AI analyzes text using natural language processing, extracts keywords and emotions such as “reliable”, “kind”, “polite explanation”, “slow response”, “felt uneasy”, “dissatisfied with nighttime response”, “staff's smile gives a sense of security”, “polite meal assistance”, and “lack of consideration during excretion assistance”, creates a reliability score and an improvement point list for each manager, analyzes a distribution of staff evaluation data and a tendency for each attribute, and also analyzes a relationship between a bias risk or a health risk score and a resignation rate or an incident occurrence rate. Specific examples of a prompt sentence to be read by the generative AI include “Calculate a resignation rate, a transfer request rate, a care quality score, and an incident occurrence rate of subordinate staff of manager X in the past year, perform emotion analysis of anonymous feedback, and extract a reliability score and an improvement point”, “Predict a care quality improvement possibility within the next half year based on a care record, a training attendance history, and a satisfaction questionnaire result of staff Y”, “Analyze staff evaluation data of manager Z for each attribute, detect presence or absence of an evaluation bias, and calculate a bias score”, and “Analyze text data of anonymous feedback by natural language processing, summarize a negative opinion, and generate an improvement proposal”. Specifically, the generative AI analysis unit executes a plurality of neural networks including a large language model and a natural language processing model. The generative AI analysis unit adopts a deep learning model based on a transformer architecture. The generative AI analysis unit receives a word embedding vector of text data as input data. The generative AI analysis unit processes, for example, a 768-dimensional floating-point number vector as an input. The generative AI analysis unit receives, as specific examples of the input data, a tensor obtained by vectorizing text “slow response” and a tensor obtained by vectorizing text “staff's smile gives a sense of security”. The generative AI analysis unit receives, as an input, a one-dimensional tensor obtained by normalizing a resignation rate and an incident occurrence rate as numerical data. The generative AI analysis unit receives, as specific examples of the input data, a normalized value indicating a resignation rate of 0.2 and a normalized value indicating an incident occurrence rate of 0.05. The generative AI analysis unit maps these input data to a high-dimensional feature space. The generative AI analysis unit calculates a contextual dependency among data using a self-attention mechanism. The generative AI analysis unit generates a reliability score and an emotion classification label as output data. The generative AI analysis unit outputs, as a format of the output data, a score represented by a floating-point number from 0.0 to 1.0 and a probability distribution vector indicating positive, negative, and neutral. The generative AI analysis unit outputs a reliability score of 0.85 and a negative probability of 0.92 as specific examples of the output data. The generative AI analysis unit transfers an output result to a subsequent process. The generative AI analysis unit generates a warning flag when the score falls below a preset threshold. The generative AI analysis unit transmits the generated flag to the evaluation report generation unit and the alert notification unit. The generative AI analysis unit executes self-supervised learning and fine-tuning as a model learning method. The generative AI analysis unit minimizes a prediction error using a cross-entropy error function. The generative AI analysis unit updates a weight parameter of the network using an error backpropagation method. The generative AI analysis unit eliminates subjective evaluation by a human by these processes. The generative AI analysis unit realizes highly accurate emotion extraction and calculation of an objective evaluation index. The generative AI analysis unit instantaneously extracts useful information from a large amount of unstructured data utilizing computing capability of a computer. The generative AI analysis unit brings about improvement in accuracy of personnel evaluation and dramatic improvement in processing speed.
Step 4: Automatic Generation and Distribution of Evaluation Report In this step, the evaluation report generation unit automatically generates an evaluation report for each manager including a resignation rate, a transfer request rate, a care quality score, a care plan achievement rate, an incident occurrence rate, a serious incident occurrence rate, a reliability score, an improvement point list, a bias detection result, and the like obtained by the generative AI analysis unit, and the report is automatically updated monthly or quarterly and can be viewed by the manager himself/herself, an upper-level manager, and an operation headquarters. For example, an evaluation report including specific numerical values and comments is automatically generated, such as “Manager X's resignation rate is 20 percent, care quality score is 4.3 points, care plan achievement rate is 95 percent, incident occurrence rate is 0.2 cases/person-year, serious incident occurrence rate is 0.05 cases/person-year, reliability score is 0.75, improvement points: enhancement of nighttime response is necessary, calling out during meal assistance should be increased, consideration during excretion assistance should be thorough, anonymous feedback: ‘polite explanation’, ‘uneasy about nighttime response’, ‘polite meal assistance’, ‘uneasy during excretion assistance’”. Specifically, the evaluation report generation unit executes a natural language generation algorithm. The evaluation report generation unit receives structured data output from the generative AI analysis unit. The evaluation report generation unit converts the structured data into unstructured text. The evaluation report generation unit holds a plurality of predefined report templates on a memory. The evaluation report generation unit dynamically selects an optimal template in accordance with an attribute of the input data. The evaluation report generation unit inserts numerical data and extracted text into a placeholder of the selected template. The evaluation report generation unit executes a dynamic hypertext markup language generation engine. The evaluation report generation unit constructs report data in a format displayable on a web browser. The evaluation report generation unit utilizes a data cache mechanism during report generation. The evaluation report generation unit omits a duplicated generation process for the same data. The evaluation report generation unit significantly reduces consumption of computing resources. The evaluation report generation unit distributes the generated report data via a secure communication channel. The evaluation report generation unit performs an encryption process so that only a user having an access authority can decrypt the report. The evaluation report generation unit completely eliminates a human cost required for report creation by these processes. The evaluation report generation unit eliminates an information delay due to real-time distribution. The evaluation report generation unit enables the latest evaluation data to be always displayed on an automatic dashboard in a monthly management meeting and daily business management. The evaluation report generation unit improves not only efficiency of a business process but also accuracy and immediacy of information transmission through automation by a computer system.
Step 5: Early Discovery of and Response to Risk by Alert Notification In this step, the alert notification unit transmits an alert in real time to a manager, an operation headquarters, and a management layer to prompt an early response when a serious risk is detected, such as when a resignation rate or an incident occurrence rate rapidly increases, or when a reliability score rapidly decreases. For example, a specific situation and a recommended action are notified, such as “The resignation rate of subordinate staff has exceeded 30 percent in the past three months. An urgent response is necessary”, “Many opinions stating ‘uneasy about nighttime response’ have been received in anonymous feedback. A review of the nighttime system is recommended”, and “The incident occurrence rate has doubled compared to the previous month. Please re-evaluate the health condition and workload of staff”. Specifically, the alert notification unit executes an anomaly detection algorithm. The alert notification unit implements a machine learning model such as an isolation forest or a one-class support vector machine. The alert notification unit receives a score array arranged in chronological order or a vector of the number of occurrences as input data. The alert notification unit receives, as specific examples of the input data, a 30-dimensional vector indicating the number of incident occurrences in the past 30 days and a time-series tensor indicating a transition of a daily reliability score. The alert notification unit compares the input data with a distribution of normal data. The alert notification unit determines whether the input data statistically significantly deviates from a normal distribution. The alert notification unit generates an anomaly score and an alert flag as output data. The alert notification unit outputs, as a format of the output data, an anomaly score in a range of 0.0 to 1.0 and an integer value indicating an importance level. The alert notification unit outputs an anomaly score of 0.95 and an importance level of 3 as specific examples of the output data. The alert notification unit activates a push notification protocol when the anomaly score exceeds a preset threshold. The alert notification unit transmits a notification message to a client terminal in real time using WebSocket communication. The alert notification unit distributes an emergency email in cooperation with an email transmission server. The alert notification unit realizes early detection of a serious risk by these processes. The alert notification unit exhibits a technical effect directly linked to prevention of an incident. The alert notification unit shortens a system response time and provides an environment in which a manager can immediately take a response action. The alert notification unit functions as a sign detection system before occurrence of a serious accident. The alert notification unit realizes continuous monitoring 24 hours a day, 365 days a year, which exceeds the limit of human monitoring capability, by computer technology.
Step 6: Visualization and Utilization of Information by User Interface In this step, a user interface unit provides an interface for each user, such as a manager, a staff member, and a person in charge of an operation headquarters, to access a server through a browser or a dedicated application, and perform viewing of an evaluation report, posting of feedback, execution of a review session, confirmation of an improvement proposal, and the like. The manager can check his/her own evaluation report, grasp a reliability score and an improvement point, and review management behavior; the staff member can post feedback anonymously, and check a past feedback history and his/her own career growth status; and the operation headquarters and a person in charge of human resources can grasp an evaluation tendency and a bias risk of an entire facility or a plurality of facilities, and utilize them for system improvement and optimization of human resource allocation. Specifically, the user interface unit executes a front-end rendering engine. The user interface unit acquires the latest data from the server using an asynchronous data fetch technology. The user interface unit dynamically updates only a part of a screen without reloading the entire page. The user interface unit reduces a drawing load on a client terminal. The user interface unit minimizes a network communication amount. The user interface unit executes a graph drawing library. The user interface unit converts time-series data and comparison data into a chart or a graph that is visually easy to understand. The user interface unit implements a role-based access control mechanism. The user interface unit dynamically restricts information to be displayed and available functions according to an authority level of a logged-in user. The user interface unit adopts a secure token authentication method. The user interface unit prevents session hijacking and unauthorized access. The user interface unit applies a responsive design. The user interface unit provides an optimal layout for devices with various screen sizes such as a personal computer, a tablet, and a smartphone. The user interface unit dramatically improves visibility and operability of information by these processes. The user interface unit provides an environment in which the user can intuitively analyze data and make a decision. The user interface unit supports various use cases such as real-time feedback viewing on a smartphone application and integrated dashboard operation for a management layer. The user interface unit brings about a technical improvement that optimizes interaction between a computer and a human.
Step 7: Execution of Feedback Posting and Review Session In this step, a feedback input unit receives posting of anonymous feedback by a staff member or a user, and a review session support unit supports a manager and a subordinate staff member to formulate a specific action plan while referring to an evaluation report, a feedback history, an improvement proposal by AI, and the like when they periodically conduct a review session. It is provided with a function of automatically listing agenda items before the session, a function of displaying past improvement actions and their effects in chronological order, a function of recording a memo and an action plan in real time during the session, a function of automatically notifying a follow-up task after the session, and the like. Specifically, the feedback input unit executes a real-time sanitization process on input text data. The feedback input unit escapes special characters to prevent a cross-site scripting attack and an SQL injection attack. The feedback input unit executes automatic tagging of input text using a natural language processing model. The feedback input unit extracts a keyword included in the text and automatically assigns a related category tag. The review session support unit executes a state machine that controls session progress. The review session support unit asynchronously acquires a past evaluation report and a feedback history from a database. The review session support unit displays the acquired data side by side on a screen in chronological order. The review session support unit presents the improvement proposal generated by the generative AI analysis unit on the screen as a prompt. The review session support unit synchronizes the memo and the action plan recorded during the session to the server in real time. The review session support unit resolves a conflict of simultaneous editing by a plurality of users using optimistic concurrency control. The review session support unit registers the follow-up task in a task management database after the session ends. The review session support unit automatically sends a reminder notification on a specified date. The review session support unit realizes automatic exclusion of inappropriate input and efficiency of session progress by these processes. The review session support unit strongly supports a regular one-on-one meeting by digital technology. The review session support unit replaces a process that relied on human memory and manual work with reliable data management and automatic notification of a computer. The review session support unit improves the quality and traceability of communication within an organization.

### (Specific Use Case)

For example, assume a case where a plurality of managers supervise their respective subordinate staff members in a nursing care facility. A data collection unit automatically acquires personnel information, such as an employment date, a resignation date, a transfer request, a reassignment history, a training attendance history, a qualification acquisition status, years of service, a past evaluation score, a promotion history, and a reward and punishment history of the subordinate staff members for each manager. Furthermore, from a care record system, it acquires a care plan achievement rate of each staff member, a daily care record, care content for each user, a care implementation frequency, detailed care content such as meal assistance, bathing assistance, excretion assistance, rehabilitation support, and recreation implementation status, a user satisfaction questionnaire result, a care satisfaction score for each user, and a record of direct gratitude and complaints from the user. From an accident/near-miss report system, it acquires the number of incident occurrences, an occurrence date and time, an occurrence location, an occurrence cause, response content, a recurrence prevention measure, an involved staff member, an incident severity classification, a follow-up status after the incident occurrence, and the like. As an inter-staff communication history, it collects a business communication system and chat history, a meeting attendance record, a business handover record, an inter-staff consultation/advice history, minutes of a regular meeting, an exchange of gratitude/praise messages between staff members, and the like. In addition, as a result of a regular stress check and health checkup, a stress level, a health risk score, guidance content from a doctor, an implementation status of health maintenance activities, a mental health consultation history, and the like are also acquired. As a result of anonymous feedback from users and families and a 360-degree evaluation, it collects a free-description opinion from a questionnaire system or a dedicated feedback system, a score by a 5-point evaluation or a 10-point evaluation, an individual comment to a specific staff member, a letter or an email from a user's family, content of a letter of appreciation or a complaint, a feedback submission frequency, a chronological change of feedback, and the like. Specifically, the data collection unit executes a parallel data acquisition process from a plurality of endpoints. The data collection unit simultaneously transmits a data request to different systems using multi-thread processing. The data collection unit conceals a network delay and shortens an overall data acquisition time. The data collection unit applies a data cleansing algorithm to the acquired data in various formats. The data collection unit executes a normalization process such as unification of a date format, conversion between full-width and half-width characters, and deletion of an unnecessary blank. The data collection unit executes a missing value imputation algorithm. The data collection unit statistically estimates and imputes a missing numerical value using a past data trend and data of a similar staff member. The data collection unit removes information that becomes noise from free-description text using natural language processing. The data collection unit executes deletion of a stop word and a stemming process. The data collection unit completely eliminates inconsistency at the time of data integration by these pre-processes. The data collection unit ensures the quality of input data in subsequent AI analysis. The data collection unit dramatically improves inference accuracy of an AI model by providing high-quality data with less noise. The data collection unit technically solves a problem of data integration in a large-scale medical corporation in which heterogeneous systems coexist or a nursing care provider operating a plurality of facilities. The data collection unit instantaneously completes a data shaping work, which takes an enormous amount of time for a human to perform manually, by high-speed calculation of a computer. The data collection unit exhibits a clear technical effect of improving efficiency and accuracy of data processing.

A database management unit organizes these data in chronological order from various perspectives such as for each manager, for each staff member, for each user, for each department, for each facility, and for each incident, and enables extraction and aggregation of, for example, a transition of a resignation rate of subordinate staff members for each manager in the past three years, a year-by-year comparison of a transfer request rate for each facility, a chronological change of a care quality score of a specific staff member, a monthly transition of the number of incident occurrences, a chronological change of anonymous feedback, a correlation analysis between a training attendance history and the care quality score, a relationship between an inter-staff communication frequency and an incident occurrence rate, a correlation between user satisfaction and a care plan achievement rate, a relationship between a health risk score of a staff member and the resignation rate, a relationship between a feedback frequency from a family and the number of complaints, and the like. Specifically, the database management unit constructs a multidimensional online analytical processing cube. The database management unit pre-aggregates data along each dimension such as a manager, a staff member, a facility, and time. The database management unit stores the pre-aggregated data in a storage as a multidimensional array. The database management unit shortens a response time to a complex aggregation query to a millisecond unit. The database management unit implements a data cache mechanism to an in-memory database. The database management unit holds a result of a frequently executed search query in a memory. The database management unit omits recalculation for the same query. The database management unit applies a dedicated compression algorithm to time-series data. The database management unit executes delta encoding that records only a change in data. The database management unit significantly reduces consumption of a storage capacity. The database management unit adopts a distributed database architecture. The database management unit horizontally scales a system by adding a storage node even when a data amount increases. The database management unit realizes high-speed search and aggregation for a large-scale and complex data set by these processes. The database management unit eliminates a waiting time when a management layer or a manager performs ad-hoc data analysis. The database management unit provides an infrastructure that supports data-driven rapid decision-making. The database management unit presents a solution by improving computer technology for a multidimensional and time-series complex analysis request that is difficult to handle with a conventional simple relational database.

A generative AI analysis unit calculates a resignation rate and a transfer request rate of subordinate staff members for each manager using these data, and outputs a quantitative index such as, for example, “among 10 subordinate staff members of manager A, 2 have resigned and 1 has submitted a transfer request in the past year, so the resignation rate is 20 percent and the transfer request rate is 10 percent”. Regarding care quality, it comprehensively evaluates a care plan achievement rate, a user satisfaction questionnaire, a training attendance history, a qualification acquisition status, diversity of care content, a care implementation frequency, a care satisfaction score for each user, a record of gratitude/complaints from users, and the like, and outputs a plurality of indices such as “an average care quality score of subordinate staff members is 4.3 points”, “the care plan achievement rate is 95 percent”, “a user satisfaction average is 4.5 points”, and “a diversity score of care content is 0.8”. Regarding accidents/near-misses, it calculates the number of reports per staff member, a major incident occurrence rate, a recurrence rate, and the like, and outputs detailed indices such as “an incident occurrence rate is 0.2 cases/person-year”, “a major incident occurrence rate is 0.05 cases/person-year”, and “an incident recurrence rate is 10 percent”. Furthermore, regarding anonymous feedback from users and families, generative AI analyzes text using natural language processing, extracts keywords and emotions such as “reliable”, “kind”, “polite explanation”, “slow response”, “felt uneasy”, “dissatisfied with night response”, “staff's smile gives a sense of security”, “polite meal assistance”, and “lack of consideration during excretion assistance”, creates a reliability score and an improvement point list for each manager, and automatically generates a specific improvement proposal such as “insufficient explanation by staff”, “uneasy about night response”, “few words spoken during meal assistance”, and “lack of consideration during excretion assistance” when there are many negative comments. It analyzes a distribution of staff evaluation data and a tendency for each attribute, detects a bias risk such as “consistently giving a low evaluation to female staff members”, “giving a high evaluation to a specific qualification holder”, “strict evaluation for newly hired staff members”, and “lenient evaluation for long-term employees”, and calculates a bias score. It also analyzes a relationship between a health risk score or a stress check result of a staff member and the resignation rate or the incident occurrence rate, and extracts a causal relationship such as “a resignation rate of a staff member with a high stress score is 1.5 times higher than an average” and “an incident occurrence rate of a staff member with a high health risk is twice as high”. Specifically, the generative AI analysis unit executes a multimodal neural network and a gradient boosting decision tree. The generative AI analysis unit includes an architecture that integrally processes text data and numerical data. The generative AI analysis unit receives an embedding vector of text and a normalized vector of numerical data as input data. The generative AI analysis unit receives, as a specific example of the input data, a one-dimensional tensor of a normalized value indicating a resignation rate of 0.2 or a 768-dimensional embedding vector obtained by converting text “slow response” by a natural language processing model. The generative AI analysis unit integrates these heterogeneous data into one feature vector in a concatenation layer. The generative AI analysis unit inputs the integrated feature vector to a fully connected layer. The generative AI analysis unit generates a bias score and a weighting coefficient of a causal relationship as output data. The generative AI analysis unit outputs, as a format of the output data, a bias score represented by a floating-point number in a range of 0.0 to 1.0 and a weighting coefficient vector indicating a contribution degree of each feature amount. The generative AI analysis unit outputs a bias score of 0.8 and a weighting coefficient of a stress score of 0.6 as a specific example of the output data. The generative AI analysis unit transfers an output result to a subsequent process. The generative AI analysis unit activates a correction processing module for evaluation data when the bias score exceeds a threshold value. The generative AI analysis unit dynamically generates a causal relationship graph based on the weighting coefficient. The generative AI analysis unit minimizes a loss function combining a cross-entropy error and a regularization term in learning of a model. The generative AI analysis unit ensures fairness of evaluation by these processes. The generative AI analysis unit extracts a hidden causal relationship that is difficult for a human to discover by calculation in a high-dimensional space. The generative AI analysis unit brings about a technical effect of dramatically enhancing objectivity of personnel evaluation by a non-conventional processing method of automatic detection of an evaluation bias.

An evaluation report generation unit automatically generates an evaluation report including specific numerical values and comments such as “manager A's resignation rate is 20 percent, care quality score is 4.3 points, care plan achievement rate is 95 percent, incident occurrence rate is 0.2 cases/person-year, major incident occurrence rate is 0.05 cases/person-year, reliability score is 0.75, improvement points: enhancement of night response is necessary, words spoken during meal assistance should be increased, consideration during excretion assistance should be thorough, anonymous feedback: ‘polite explanation’, ‘uneasy about night response’, ‘polite meal assistance’, ‘uneasy during excretion assistance’” based on these analysis results, and the report is automatically updated monthly or quarterly and can be viewed by the manager himself/herself, an upper-level manager, and an operation headquarters. When the resignation rate or the incident occurrence rate rapidly increases, or when the reliability score rapidly decreases, an alert notification unit transmits a warning to a related person in real time, and notifies a specific situation and a recommended action such as “the resignation rate of subordinate staff members has exceeded 30 percent in the past three months. Urgent response is necessary”, “many opinions stating ‘uneasy about night response’ have been received in anonymous feedback. Review of a night system is recommended”, and “the incident occurrence rate has doubled compared to the previous month. Please re-evaluate the health condition and workload of staff members”. Specifically, the evaluation report generation unit executes a dynamic content generation engine. The evaluation report generation unit reads various scores and text data output from the generative AI analysis unit into a memory as a structured object. The evaluation report generation unit parses the structured object and constructs a hypertext document according to a predefined report schema. The evaluation report generation unit cooperates with a real-time stream processing framework. When detecting an update of a data source, the evaluation report generation unit immediately regenerates report content of a corresponding part. The alert notification unit operates based on an event-driven architecture. The alert notification unit receives an anomaly detection event via a message queuing system. The alert notification unit determines routing of a notification according to an importance level of the event. The alert notification unit executes an immediate push notification and an emergency email transmission in parallel for an event of high importance. The alert notification unit collectively notifies an event of low importance as a summary report by a daily batch process. The evaluation report generation unit and the alert notification unit reduce latency of report generation to the utmost limit by these processes. The evaluation report generation unit and the alert notification unit optimize consumption of a network bandwidth. The evaluation report generation unit and the alert notification unit always display the latest and important information without delay on an integrated dashboard for an area manager who supervises a plurality of facilities. The evaluation report generation unit and the alert notification unit guarantee freshness of information and certainty of transmission by computer technology, and improve crisis management capability of an organization.

A user interface unit allows each user, such as a manager, a staff member, and a person in charge of an operation headquarters, to access a server through a browser or a dedicated application, and perform viewing of an evaluation report, posting of feedback, execution of a review session, confirmation of an improvement proposal, and the like. The manager can check his/her own evaluation report, grasp a reliability score and an improvement point, and review management behavior; the staff member can post feedback anonymously, and check a past feedback history and his/her own career growth status; and the operation headquarters and a person in charge of human resources can grasp an evaluation tendency and a bias risk of an entire facility or a plurality of facilities, and utilize them for system improvement and optimization of human resource allocation. Specifically, the user interface unit is constructed using a single-page application framework. The user interface unit speeds up screen drawing by manipulating a virtual document object model. The user interface unit uses a representational state transfer application programming interface for communication with the server. The user interface unit implements a secure authentication mechanism using a JSON web token. The user interface unit encrypts and stores a token issued at the time of user login in a local storage. The user interface unit adds the token to a header and transmits it for each request to the server. The user interface unit verifies a signature of the token on a server side and confirms that there is no falsification. The user interface unit refers to a role-based access control list. The user interface unit dynamically reconfigures an interface so that a general staff member can view only his/her own data and the manager can view data of subordinate staff members. The user interface unit strongly prevents information leakage by these processes. The user interface unit establishes a secure communication channel and ensures data safety in a personnel evaluation system that handles personal information. The user interface unit automatically controls appropriate information disclosure according to user authority. The user interface unit reliably and rapidly executes complex access authority management as a technical process inside a computer.

Specific examples of a prompt sentence to be read by generative AI include “calculate a resignation rate, a transfer request rate, a care quality score, and an incident occurrence rate of subordinate staff members of manager A in the past year, perform emotion analysis of anonymous feedback, and extract a reliability score and an improvement point”, “predict a possibility of care quality improvement within the next half year based on a care record, a training attendance history, and a satisfaction questionnaire result of staff member B”, “analyze staff evaluation data of manager C for each attribute, detect presence or absence of an evaluation bias, and calculate a bias score”, and “analyze text data of anonymous feedback by natural language processing, summarize a negative opinion, and generate an improvement proposal”. Specifically, a generative AI analysis unit executes a dynamic prompt generation algorithm based on a prompt engineering technology. The generative AI analysis unit reads a predefined prompt template from a database. The generative AI analysis unit acquires attribute information and a past evaluation history of a target manager as context data by vectorizing them. The generative AI analysis unit embeds the context data in a variable part of the template. The generative AI analysis unit transmits a completed prompt character string to a large language model as input data. The generative AI analysis unit receives, as a specific example of the input data, a character string token sequence “generate an improvement proposal with manager A's resignation rate of 0.2 and care quality score of 4.3 as input”. The generative AI analysis unit executes an inference engine of the large language model. The generative AI analysis unit receives a generated text token sequence as output data. The generative AI analysis unit outputs a text token sequence “enhancement of night response is recommended” as a specific example of the output data. The generative AI analysis unit applies a hallucination detection filter to the output text. The generative AI analysis unit verifies whether the generated text is consistent with factual data using a logic check algorithm. The generative AI analysis unit suppresses a hallucination phenomenon of AI by these processes. The generative AI analysis unit dramatically improves stability and reliability of output. The generative AI analysis unit safely and highly accurately executes automatic text generation based on various evaluation criteria. The generative AI analysis unit saves time and effort for a human to manually create a prompt, and realizes complete automation by a system.

In this way, by using the system of the present invention, it is possible to multilaterally and objectively visualize manager evaluation in a nursing care site, and strongly support retention of staff members, improvement of care quality, improvement of user satisfaction, and sound organizational operation. Specifically, the system executes an orchestration engine that integrally controls a data flow between respective modules. The system accumulates an evaluation result and feedback from a user in a database management unit again. The system utilizes the accumulated data as re-learning data of a generative AI analysis unit. The system executes a continuous machine learning pipeline. The system fine-tunes a weight parameter of a model every time new data is added. The system autonomously improves accuracy of evaluation and accuracy of prediction over time. The system forms a feedback loop. The system continuously monitors performance of the entire system, automatically detects a bottleneck, and dynamically allocates a resource. The system functions as an autonomous optimization system beyond a mere business efficiency improvement tool by these processes. The system enables construction of a standard personnel evaluation platform in the entire nursing care industry. The system directly contributes to solving problems in human society through improvement of computer technology. The system seamlessly integrates all processes from data collection to analysis, report generation, and feedback, and strongly promotes soundness of organizational operation by advanced information processing technology.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

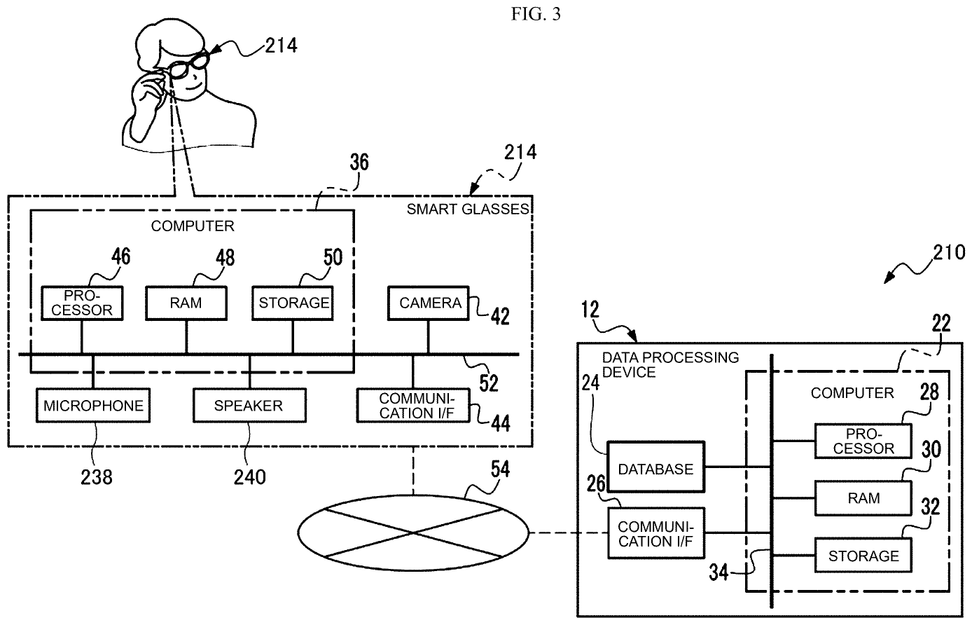

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

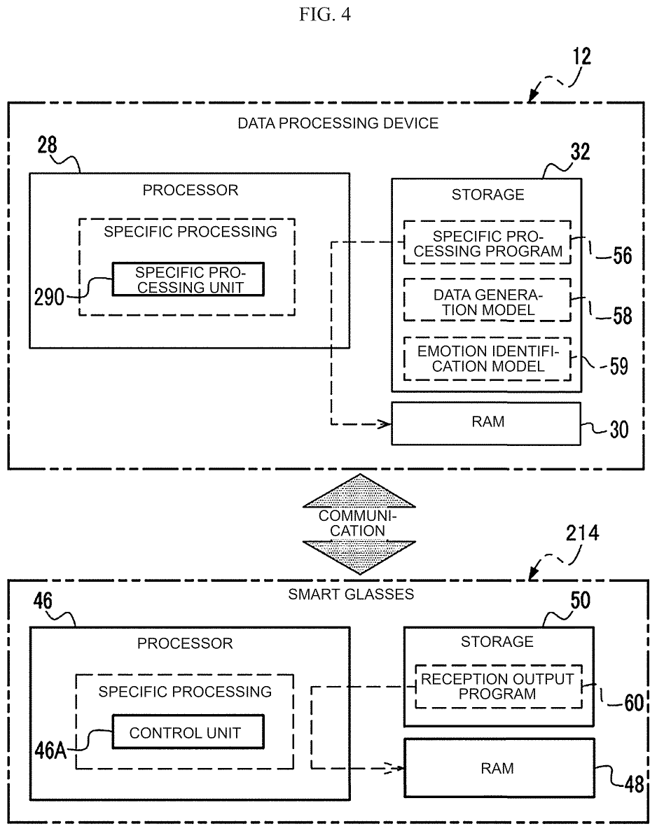

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

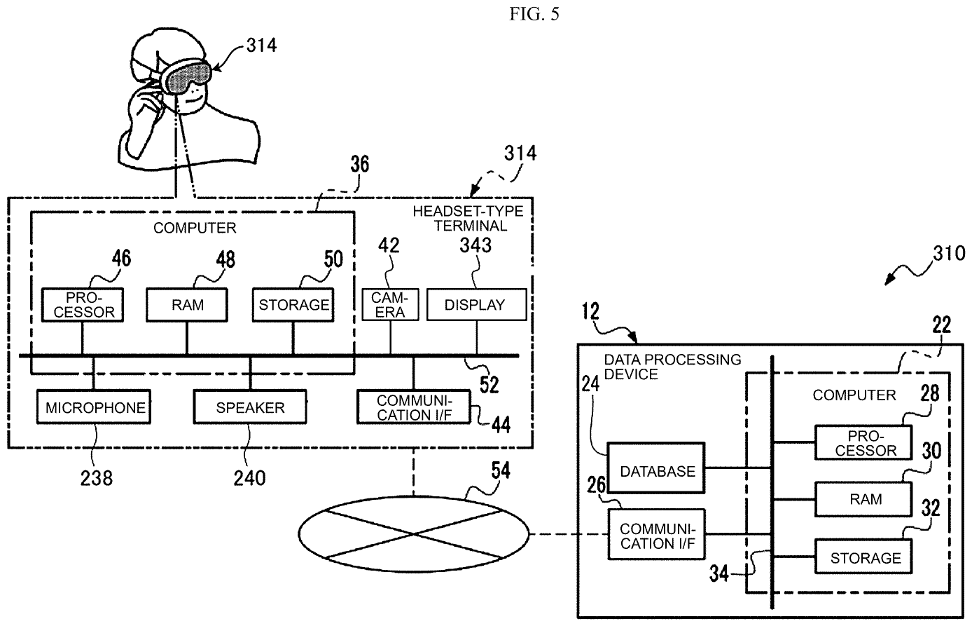

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

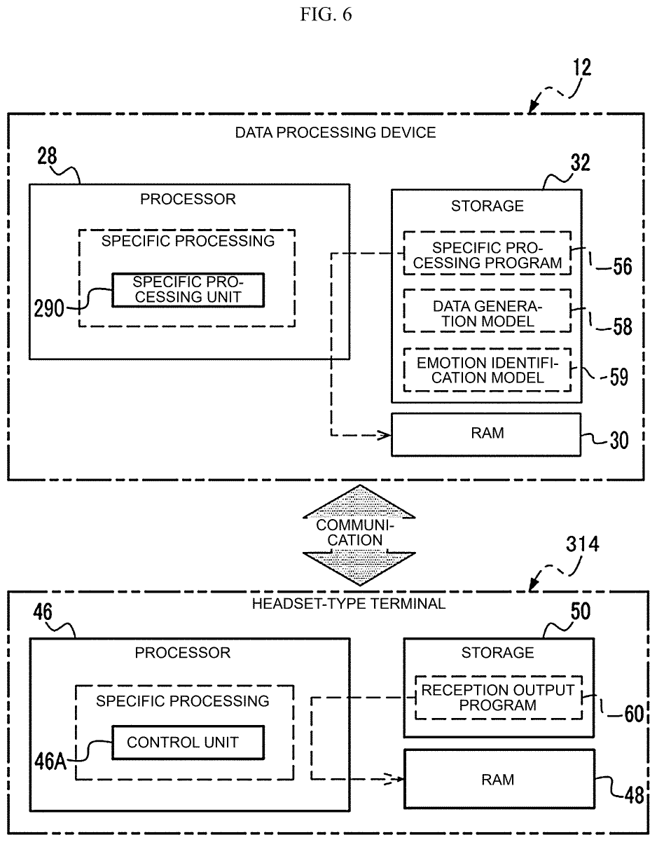

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

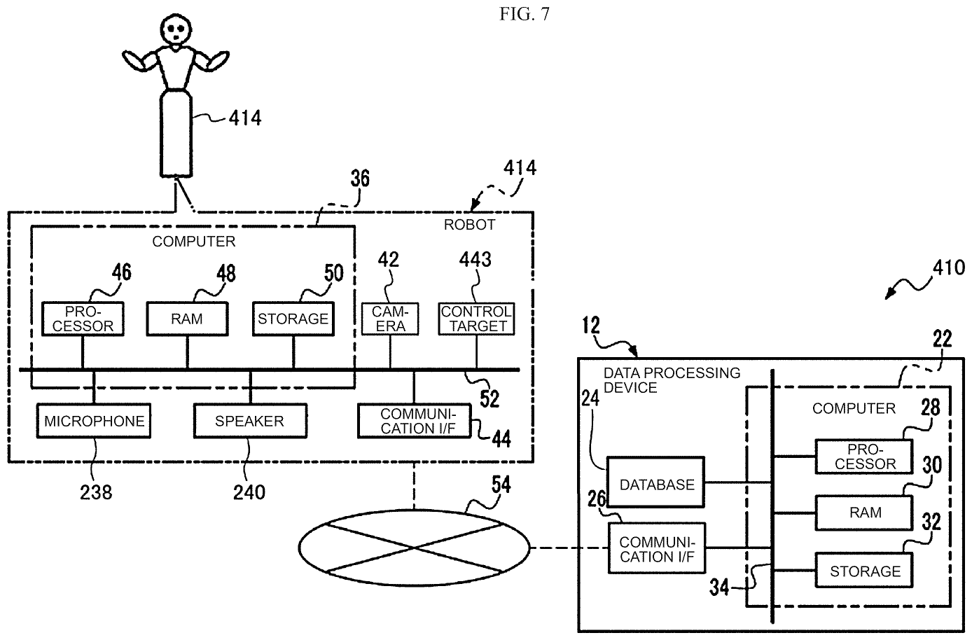

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

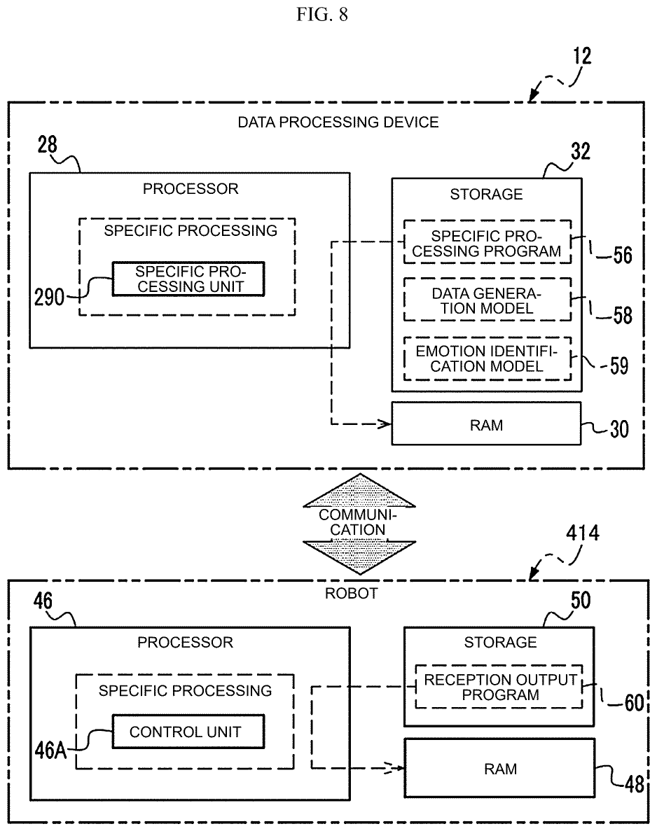

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

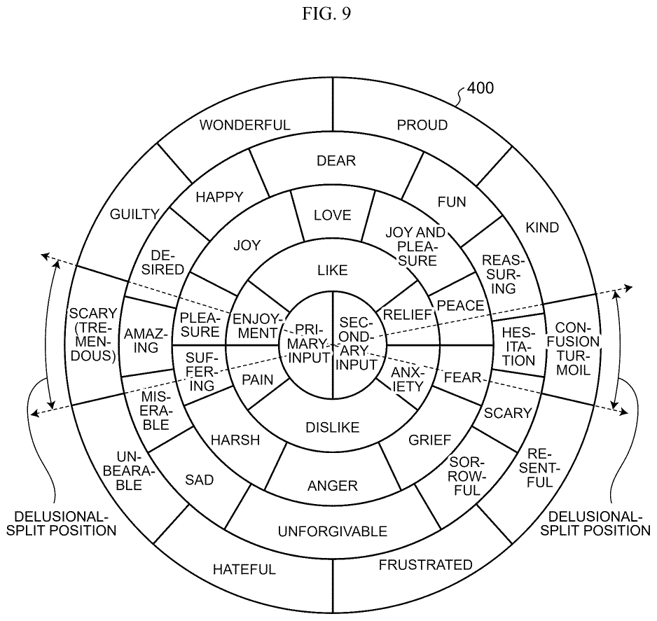

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

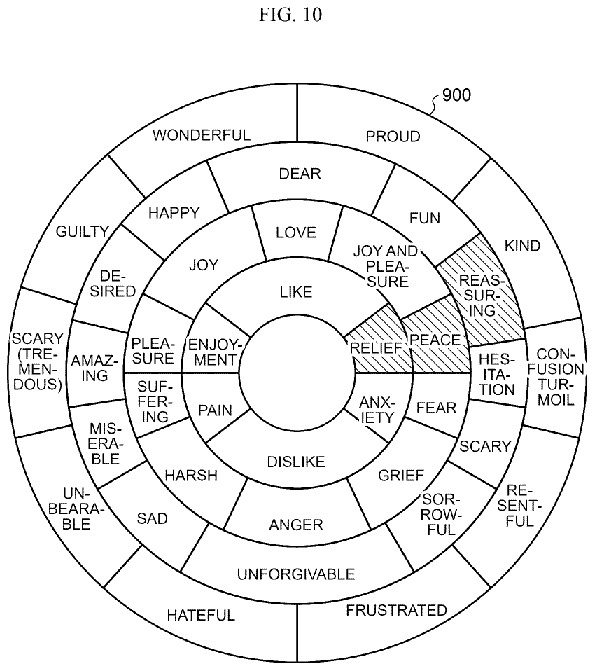

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A manager evaluation system in a nursing care site, the system comprising: a data collection unit; a generative AI analysis unit; and an evaluation report generation unit, wherein the data collection unit is configured to automatically and comprehensively collect diverse information, such as personnel data of nursing care staff, resignation/transfer request/reassignment history, training attendance history, qualification acquisition status, care plan achievement rate, user satisfaction questionnaire, accident/near-miss report, inter-staff communication history, anonymous feedback from users and families, and results of health checkups and stress checks, from a plurality of databases and systems inside and outside a nursing care facility; the generative AI analysis unit is configured to: quantitatively calculate a resignation rate, a transfer request rate, a care quality score, and an incident occurrence rate of subordinate staff for each manager using various data acquired by the data collection unit; extract a reliability score and an improvement point list by analyzing the anonymous feedback from the users and the families by a natural language processing technology; and detect presence or absence of a subjective bias by analyzing a distribution of staff evaluation data and a tendency for each attribute; and the evaluation report generation unit is configured to automatically generate an evaluation report for each manager including the resignation rate, the transfer request rate, the care quality score, the incident occurrence rate, the reliability score, the improvement point list, a bias detection result, and the like obtained by the generative AI analysis unit, and distribute the evaluation report to the manager himself/herself, an upper-level manager, and an operation headquarters periodically or in real time.

### (Supplementary Note 2)

The system according to Supplementary Note 1, wherein the generative AI analysis unit is configured to: analyze feedback data anonymously collected from the users and the families by the natural language processing technology; calculate the reliability score; automatically summarize a negative opinion and an improvement request; extract a current state of a relationship of trust and a specific point to be improved for each manager; and provide these to the evaluation report generation unit, thereby realizing visualization of the relationship of trust between the manager, the subordinate staff, and the users, and an improvement proposal.

### (Supplementary Note 3)

The system according to Supplementary Note 1, wherein the evaluation report generation unit is configured to: automatically generate the evaluation report including the resignation rate, the transfer request rate, the care quality score, the incident occurrence rate, the bias detection result, the reliability score, the improvement point list, and the like for each manager periodically or in real time based on an analysis result by the generative AI analysis unit; distribute the evaluation report in a form viewable by the manager himself/herself, the upper-level manager, and the operation headquarters; ensure transparency of an evaluation process; and enable the evaluation report to be utilized as an objective basis when the manager and the subordinate staff conduct a review session.

What is claimed is:

1. A system comprising:
circuitry configured to:
receive, via a communication interface coupled to a packet-switched network, numerical parameter records and unstructured text data records from a plurality of data source endpoints, and store the numerical parameter records and unstructured text data records in a storage device;
aggregate numerical parameters extracted from the numerical parameter records over a specified time window to compute statistical feature vectors for each entity identifier;
apply a transformer-based natural language processing model to the unstructured text data records to extract sentiment polarity scores, key phrase embeddings, and topic classification labels;
apply a statistical distribution analysis model to the numerical parameter records to compute score distribution parameters for each entity identifier, compute a Kullback-Leibler divergence between an observed score distribution vector and a reference distribution vector, and generate a distributional deviation signal when the divergence exceeds a divergence threshold parameter;
apply a generative neural network model comprising a multimodal encoder architecture to the statistical feature vectors, the sentiment polarity scores, the key phrase embeddings, and the distributional deviation signal to generate output prediction vectors and ranked inference output data records; and
transmit the output prediction vectors and the ranked inference output data records to terminal devices via the communication interface.

2. The system according to claim 1, wherein the circuitry is configured to establish connections to a plurality of external data source systems via an asynchronous communication protocol and periodic polling, extract numerical parameter fields and text data fields from each data source system, and merge the extracted data into a unified record schema in the storage device using entity identifier keys.

3. The system according to claim 2, wherein the circuitry is configured to apply the transformer-based natural language processing model to unstructured text data records comprising free-description text fields, generate a sentiment polarity score on a continuous numerical scale for each text record, and extract key phrase embeddings by applying positional encoding to token sequences and computing attention-weighted representations.

4. The system according to claim 3, wherein the circuitry is configured to aggregate sentiment polarity scores over a time series for each entity identifier, apply a moving average filter to the aggregated sentiment polarity score series to extract a trend component, and detect a sentiment trend deviation by comparing the current trend component against a historical baseline sentiment pattern stored in the storage device.

5. The system according to claim 1, wherein the circuitry is configured to compute a score distribution vector for each entity identifier from the numerical parameter records comprising a mean, a standard deviation, and a skewness parameter of numerical evaluation scores, compare the score distribution vector against a population distribution vector computed from all stored numerical parameter records, and generate a bias detection flag when the Kullback-Leibler divergence between the score distribution vector and the population distribution vector exceeds the divergence threshold parameter.

6. The system according to claim 5, wherein the circuitry is configured to generate a bias indicator record comprising the entity identifier, the bias detection flag, and a dimensional attribution vector identifying evaluation criteria dimensions with the highest distributional deviation, and incorporate the bias indicator record as an input feature to the generative neural network model during ranked inference output data record generation.

7. The system according to claim 1, wherein the circuitry is configured to apply the generative neural network model to the statistical feature vectors and a longitudinal record of historical statistical feature vectors stored in the storage device to compute the output prediction vectors indicating a probability of future state transition events, and generate a confidence score for each output prediction vector based on the volume and recency of underlying numerical parameter records.

8. The system according to claim 7, wherein the circuitry is configured to retrieve reference records from a vector database by computing cosine similarity scores between a query embedding vector derived from the key phrase embeddings and stored reference record embedding vectors, and incorporate the retrieved reference records in a retrieval-augmented generation prompt for generating the ranked inference output data records.

9. The system according to claim 1, wherein the circuitry is configured to apply an anonymization transformation to the unstructured text data records prior to natural language processing by replacing entity identifiers with anonymized tokens while preserving semantic content, and store anonymized text data records separately from identified numerical parameter records in the storage device.

10. The system according to claim 9, wherein the circuitry is configured to aggregate extracted key phrase embeddings across all anonymized text data records associated with a given entity identifier to generate a consolidated feedback feature vector, and apply the generative neural network model to the consolidated feedback feature vector to generate a summarization text and an improvement point list for inclusion in the ranked inference output data records.

11. The system according to claim 1, wherein the circuitry is configured to apply a regression model to the output prediction vectors and historical statistical feature vectors to generate a future state projection curve over a configurable time horizon, and incorporate the future state projection curve as a time-series visualization data component in the ranked inference output data records.

12. The system according to claim 1, wherein the circuitry is configured to generate an alert notification when a statistical feature vector for an entity identifier crosses a threshold value, apply the generative neural network model to generate an alert explanation text and recommended action items, and transmit the alert notification and alert explanation text to a designated recipient terminal device via the communication interface.

13. The system according to claim 12, wherein the circuitry is configured to apply the generative neural network model to the alert explanation text and historical ranked inference output data records associated with the entity identifier to generate a session support document comprising discussion agenda items and response guidance text, and transmit the session support document to the terminal device via the communication interface.

14. The system according to claim 1, wherein the circuitry is configured to control ranked inference output data record access by applying a role-based access control policy limiting access to report sections based on a requester role parameter associated with the terminal device, and generate redacted output data records omitting restricted sections for terminal devices associated with role parameters below an authorization level threshold.

15. The system according to claim 1, wherein the circuitry is configured to update the generative neural network model by generating training pairs from historical output prediction vectors and corresponding validated outcome data, and fine-tune the generative neural network model on the training pairs to reduce mean squared error between predicted state transition scores and observed outcomes.

16. The system according to claim 1, wherein the circuitry is configured to schedule automated ranked inference output data record generation at a configurable periodic interval, apply the generative neural network model to the most recently aggregated statistical feature vectors and sentiment polarity scores, and transmit the generated output data records to recipient terminal devices identified in a distribution parameter associated with each entity identifier.

17. The system according to claim 1, wherein the numerical parameter records comprise quantitative outcome metrics aggregated over time for each entity identifier, and the unstructured text data records comprise free-description text submitted by associated data source endpoints.

18. A system comprising:
circuitry configured to:
receive, via a communication interface coupled to a packet-switched network, numerical parameter records and unstructured text data records from a plurality of data source endpoints;
apply a transformer-based natural language processing model to extract sentiment polarity scores and key phrase embeddings, and apply a statistical distribution analysis model to compute Kullback-Leibler divergence and generate a distributional deviation signal;
aggregate numerical parameters over a time window to compute statistical feature vectors, and apply a regression model to compute output prediction vectors for future state transition events;
apply a generative neural network model comprising a multimodal encoder architecture to the statistical feature vectors, sentiment polarity scores, key phrase embeddings, distributional deviation signal, and output prediction vectors to generate ranked inference output data records; and
transmit the output prediction vectors and ranked inference output data records to terminal devices via the communication interface.

19. The system according to claim 18, wherein the circuitry is configured to retrieve reference records from a vector database by cosine similarity search using query embedding vectors derived from the key phrase embeddings, incorporate the retrieved reference records in a retrieval-augmented generation prompt, and generate a session support document from the ranked inference output data records comprising discussion agenda items and response guidance text for transmission to a terminal device.

20. A method comprising:
receiving, via a communication interface coupled to a packet-switched network, numerical parameter records and unstructured text data records from a plurality of data source endpoints, and storing the numerical parameter records and unstructured text data records in a storage device;
aggregating numerical parameters extracted from the numerical parameter records over a specified time window to compute statistical feature vectors for each entity identifier;
applying a transformer-based natural language processing model to the unstructured text data records to extract sentiment polarity scores, key phrase embeddings, and topic classification labels;
applying a statistical distribution analysis model to compute a Kullback-Leibler divergence between an observed score distribution vector and a reference distribution vector, and generating a distributional deviation signal when the divergence exceeds a divergence threshold parameter;
applying a generative neural network model comprising a multimodal encoder architecture to the statistical feature vectors, the sentiment polarity scores, the key phrase embeddings, and the distributional deviation signal to generate output prediction vectors and ranked inference output data records; and
transmitting the output prediction vectors and the ranked inference output data records to terminal devices via the communication interface.
